(19) United States
(12) Patent Application Publication
(10) Pub. No.: US 2019/0191705 A1
(43) Pub. Date: Jun. 27, 2019

(54) EUGLENA GRACILIS AS A PLANT BIOSTIMULANT

(71) Applicant: KEMIN INDUSTRIES, INC., DES MOINES, IA (US)

(72) Inventor: Emily-Jean K. FUERST, Ames, IA (US)

(21) Appl. No.: 16/153,487

(22) Filed: Oct. 5, 2018

Related U.S. Application Data
(60) Provisional application No. 62/569,434, filed on Oct. 6, 2017.

(51) Int. Cl. A01N 63/00; A01N 63/02; A01N 25/12

(52) U.S. Cl. CPC A01N 63/00; A01N 25/12; A01N 63/02

(57) ABSTRACT

The present invention relates to methods for improving, protecting, and stimulating the growth of plants, including but not limited to applying a composition containing Euglena gracilis or paramylon as a plant biostimulant at various stages of plant growth. Another aspect of the present invention relates to methods for increasing crop yield using Euglena gracilis or its derivatives, including but not limited to top dress or soil incorporate applications.

### CROSS-REFERENCE TO RELATED APPLICATION(S)

This application claims the benefit of priority to U.S. Provisional Patent Application No. 62/569,434, filed Oct. 6, 2017, entitled “EUGLENA GRACILIS AS A PLANT BIOSTIMULANT,” the disclosure of which is hereby incorporated herein by reference in its entirety.

### BACKGROUND OF THE INVENTION

Global demand for sustainability continues to drive consumer choices in production markets. Agricultural production markets, in particular, are increasingly motivated to incorporate sustainable practices to their trade from the time the seed is sown to the day the plant lands on supermarket shelves. Consumer outcry for more sustainable and organic produce is often combined, and at odds with, the equally demanding consumer cry for healthier, larger, more vibrant crops, as well as the global need for a dramatic increase in food production to feed a rapidly growing population.

One potential solution to this paradox is the growing and promising field of plant biostimulants. Plant biostimulants are generally understood as any chemical substance or microorganism that improves the plants' ability to acquire nutrients from the soil, metabolize and utilize nutrients, resist abiotic stresses, and/or to enhance the overall health of the plant (see http://www.sciencedirect.com/science/article/pii/S0304423815301850). Plant biostimulants operate by improving plant nutrient efficiency, quality, biomass, and resistance to abiotic stresses. Compared to fertilizers, plant biostimulants operate through different mechanisms, and may be used in conjunction with fertilizers to maximize nutrient uptake and efficiency. The application of a biostimulant is also exogenous and independent of a plant's actual nutrient makeup. Finally, a plant biostimulant is naturally derived, sustainably produced, and safe to apply. These qualities support biostimulant use as an all-purpose plant growth enhancement that meets the sustainability demands of growers and consumers in all areas where agricultural production takes place.

Industry reports estimate that the plant biostimulant market enjoys a global growth rate of 10.20% every year, with an expected value of $3.18B by the year 2022. Broken down by region, it is estimated that 40% of this market stays in Europe while North America constitutes only a little over 13% of the global biostimulant industry.

### SUMMARY OF THE INVENTION

The present invention relates to methods for improving, protecting, and stimulating the growth of plants, including but not limited to using a whole cell Euglena gracilis or paramylon as a plant biostimulant. Another aspect of the invention relates to various application methods and rates, such as applying the plant stimulant at a rate of at least 0.007 g/L, using various known methods and applying the plant stimulant at various stages of plant growth. Another aspect of the present invention relates to methods for increasing crop yield using whole cell Euglena gracilis or paramylon, including but not limited to top dress or soil incorporated applications.

### BRIEF DESCRIPTION OF THE DRAWINGS

FIG. 1 is a chart depicting U.S. organic food sales.

FIG. 2A is a photograph showing representative plug root score images for geranium.

FIG. 2B is a photograph showing representative plug root score images for vinca.

FIG. 3 is a photograph showing representative pot root scoring for geranium.

FIG. 3B is a photograph showing representative pot root scoring for vinca.

FIG. 4 explains how flowering was recorded as the date a bloomed or blooming flower was noticed on a plant. A flower was recorded if the petals displayed signs of blooming and began to show distinct colors.

FIG. 5A is a chart of the days to emergence for geranium with treatments of Valena at different rates and application methods. Data is presented as the average±the standard deviation. Statistically significant (p-value<0.05) effects compared to the negative control are noted with an asterisk (*).

FIG. 5B is a chart of the days to emergence for vinca with treatments of Valena at different rates and application methods. Data is presented as the average±the standard deviation. Statistically significant (p-value<0.05) effects compared to the negative control are noted with an asterisk (*).

FIG. 6A is a chart of stem height in plugs treated with Valena for geranium. Data is presented as the average±the standard deviation (N=50). Statistically significant (p-value<0.05) effects compared to the negative control are noted with an asterisk (*).

FIG. 6B is a chart of stem height in plugs treated with Valena for vinca. Data is presented as the average±the standard deviation (N=50). Statistically significant (p-value<0.05) effects compared to the negative control are noted with an asterisk (*).

FIG. 7A is a chart of lateral stem height in plugs treated with Valena for geranium. Data is presented as the average±the standard deviation (N=50). Statistically significant (p-value<0.05) effects compared to the negative control are noted with an asterisk (*).

FIG. 7B is a chart of lateral stem height in plugs treated with Valena for vinca. Data is presented as the average±the standard deviation (N=50). Statistically significant (p-value<0.05) effects compared to the negative control are noted with an asterisk (*).

FIG. 8A is a chart of wet weight of geranium plug plants treated with Valena. Data is presented as the average±the standard deviation (N=50). Statistically significant (p-value<0.05) effects compared to the negative control are noted with an asterisk (*).

FIG. 8B is a chart of wet weight of vinca plug plants treated with Valena. Data is presented as the average±the standard deviation (N=50). Statistically significant (p-value<0.05) effects compared to the negative control are noted with an asterisk (*).

FIG. 9A is a chart of dry weight of geranium plug plants treated with Valena. Data is presented as the average±the standard deviation (N=50). Statistically significant (p-value<0.05) effects compared to the negative control are noted with an asterisk (*).

FIG. 9B is a chart of dry weight of vinca plug plants treated with Valena. Data is presented as the average±the standard deviation (N=50). Statistically significant (p-value<0.05) effects compared to the negative control are noted with an asterisk (*).

FIG. 10A is a chart of root score of geranium plug plants treated with Valena. Data is presented as the average±the standard deviation (N=50). Statistically significant (p-value<0.05) effects compared to the negative control are noted with an asterisk (*).

FIG. 10B is a chart of root score of vinca plug plants treated with Valena. Data is presented as the average±the standard deviation (N=50). Statistically significant (p-value<0.05) effects compared to the negative control are noted with an asterisk (*).

FIG. 11 is a chart of percent average growth increase of geranium and vinca treated with Valena either incorporated into the soilless medium or as a drench.

FIG. 12A is a chart of stem height for geranium in potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 12B is a chart of stem height for vinca in potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 13A is a chart of lateral stem height for geranium in potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 13B is a chart of lateral stem height for vinca in potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 14A is a chart of plant wet weight for geranium potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 14B is a chart of plant wet weight for vinca potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 15A is a chart of plant dry weight for geranium potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 15B is a chart of plant dry weight for vinca potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 16A is a chart of root score for geranium potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 16B is a chart of root score for vinca potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 17A is a chart of days to flower for geranium potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 17B is a chart of days to flower for vinca potted plants that have been treated either at the plug phase (TU), pot phase (UT), or both phases (TT) with 1.5 g/L Valena as compared to untreated plants at both phases (UU). Data represented as the average±standard deviation for each treatment (N=30). Statistically significant (p-value<0.05) effects compared to the negative control are noted with an asterisk (*).

FIG. 18 is a chart of percent average growth difference of geranium and vinca treated with Valena at either only at the plug phase (UT), the pot phase (TU), or both plug and pot phase (TT) in the soilless medium (soil) or as a watered in top dress (drench) for geranium and vinca grown to finish as compared to the negative control.

FIG. 19 is a photograph showing representative root hair scores for melon, bell pepper, tomato, and vinca where 0 is the lowest root observance and 3 or 4, respective to the plant, is the highest observable root growth.

FIG. 20 is a chart of days to germination of treated plant seeds.

FIG. 21 is a chart of mesocotyl length of treated seedlings one week after germination.

FIG. 22 is a chart of radicle length of treated seedlings one week after germination.

FIG. 23 is a chart of root hair scores of treated seedlings one week after germination.

FIG. 24 is a photograph showing representative plug root score images for tomatoes.

FIG. 25 is a photograph showing representative plug root score images for impatiens.

FIG. 26A is a chart of plug stem heights of tomatoes for treatments of Valena, IA, and AKM at different rates and water statuses (N=150). Data is presented as the average±the standard error. Statistically significant (p-value<0.05) effects compared to the respective negative control are noted with letters (a-g).

FIG. 26B is a chart of plug stem heights of impatiens for treatments of Valena, IA, and AKM at different rates and water statuses (N=150). Data is presented as the average±the standard error. Statistically significant (p-value<0.05) effects compared to the respective negative control are noted with letters (a-g).

FIG. 27A is a chart of plug lateral stem heights of tomatoes for treatments of Valena, IA, and AKM at different rates and water statuses (N=150). Data is presented as the average±the standard error. Statistically significant (p-value<0.05) effects compared to the respective negative control are noted with a letter (a-g).

FIG. 27B is a chart of plug lateral stem heights of impatiens for treatments of Valena, IA, and AKM at different rates and water statuses (N=150). Data is presented as the average±the standard error. Statistically significant (p-value<0.05) effects compared to the respective negative control are noted with a letter (a-g).

FIG. 28A is a chart of plug wet weights of tomatoes for treatments of Valena, IA, and AKM at different rates and water statuses (N=150). Data is presented as the average±the standard error. Statistically significant (p-value<0.05) effects compared to the respective negative control are noted with a letter (a-g).

FIG. 28B is a chart of plug wet weights of impatiens for treatments of Valena, IA, and AKM at different rates and water statuses (N=150). Data is presented as the average±the standard error. Statistically significant (p-value<0.05) effects compared to the respective negative control are noted with a letter (a-g).

FIG. 29A is a chart of plug dry weights of tomatoes for treatments of Valena, IA, and AKM at different rates and water statuses (N=150). Data is presented as the average±the standard error. Statistically significant (p-value<0.05) effects compared to the respective negative control are noted with a letter (a-g).

FIG. 29B is a chart of plug dry weights of impatiens for treatments of Valena, IA, and AKM at different rates and water statuses (N=150). Data is presented as the average±the standard error. Statistically significant (p-value<0.05) effects compared to the respective negative control are noted with a letter (a-g).

FIG. 30A is a chart of plug root scores of tomatoes for treatments of Valena, IA, and AKM at different rates and water statuses (N=150). Data is presented as the average±the standard error. Statistically significant (p-value<0.05) effects compared to the respective negative control are noted with a letter (a-g).

FIG. 30B is a chart of plug root scores of impatiens for treatments of Valena, IA, and AKM at different rates and water statuses (N=150). Data is presented as the average±the standard error. Statistically significant (p-value<0.05) effects compared to the respective negative control are noted with a letter (a-g).

FIG. 31A is a chart of tomato bud counts for soil incorporated watered at days 60, 90, and 120 for treatments of Valena and AKM at different rates. Data is presented as the average±the standard error. Statistically significant (p-value<0.05) effects compared to the respective negative control are notes with an asterisk (*).

FIG. 31B is a chart of tomato bud counts for soil incorporated drought at days 60, 90, and 120 for treatments of Valena and AKM at different rates. Data is presented as the average±the standard error. Statistically significant (p-value<0.05) effects compared to the respective negative control are notes with an asterisk (*).

FIG. 31C is a chart of tomato bud counts for top dressed watered at days 60, 90, and 120 for treatments of Valena and AKM at different rates. Data is presented as the average±the standard error. Statistically significant (p-value<0.05) effects compared to the respective negative control are notes with an asterisk (*).

FIG. 31D is a chart of tomato bud counts for top dressed drought at days 60, 90, and 120 for treatments of Valena and AKM at different rates. Data is presented as the average±the standard error. Statistically significant (p-value<0.05) effects compared to the respective negative control are notes with an asterisk (*).

FIG. 32A is a chart of tomato flower counts for soil incorporated watered at days 60, 90, and 120 for treatments of Valena and AKM at different rates. Data is presented as the average±the standard error. Statistically significant (p-value<0.05) effects compared to the respective negative control are notes with an asterisk (*).

FIG. 32B is a chart of tomato flower counts for soil incorporated drought at days 60, 90, and 120 for treatments of Valena and AKM at different rates. Data is presented as the average±the standard error. Statistically significant (p-value<0.05) effects compared to the respective negative control are notes with an asterisk (*).

FIG. 32C is a chart of tomato flower counts for top dressed watered at days 60, 90, and 120 for treatments of Valena and AKM at different rates. Data is presented as the average±the standard error. Statistically significant (p-value<0.05) effects compared to the respective negative control are notes with an asterisk (*).

FIG. 32D is a chart of tomato flower counts for top dressed drought at days 60, 90, and 120 for treatments of Valena and AKM at different rates. Data is presented as the average±the standard error. Statistically significant (p-value<0.05) effects compared to the respective negative control are notes with an asterisk (*).

FIG. 33A is a chart of tomato counts for soil incorporated watered at days 60, 90, and 120 for treatments of Valena and AKM at different rates. Data is presented as the average±the standard error. Statistically significant (p-value<0.05) effects compared to the respective negative control are notes with an asterisk (*).

FIG. 33B is a chart of tomato counts for soil incorporated drought at days 60, 90, and 120 for treatments of Valena and AKM at different rates. Data is presented as the average±the standard error. Statistically significant (p-value<0.05) effects compared to the respective negative control are notes with an asterisk (*).

FIG. 33C is a chart of tomato counts for top dressed watered at days 60, 90, and 120 for treatments of Valena and AKM at different rates. Data is presented as the average±the standard error. Statistically significant (p-value<0.05) effects compared to the respective negative control are notes with an asterisk (*).

FIG. 33D is a chart of tomato counts for top dressed drought at days 60, 90, and 120 for treatments of Valena and AKM at different rates. Data is presented as the average±the standard error. Statistically significant (p-value<0.05) effects compared to the respective negative control are notes with an asterisk (*).

FIG. 34A is a chart of breaker tomato height results (N=36/treatment) for soil incorporated application of Valena and AKM at different rates and water statuses. Data is presented as the average±the standard error. Statistically significant (p-value<0.05) effects compared to the respective negative control are noted with an asterisk (*).

FIG. 34B is a chart of breaker tomato height results (N=36/treatment) for top dressed application of Valena and AKM at different rates and water statuses. Data is presented as the average±the standard error. Statistically significant (p-value<0.05) effects compared to the respective negative control are noted with an asterisk (*).

FIG. 35A is a chart of breaker tomato diameter results (N=36/treatment) for soil incorporated application of Valena and AKM at different rates and water statuses. Data is presented as the average±the standard error. Statistically significant (p-value<0.05) effects compared to the respective negative control are noted with an asterisk (*).

FIG. 35B is a chart of breaker tomato diameter results (N=36/treatment) for top dressed application of Valena and AKM at different rates and water statuses. Data is presented as the average±the standard error. Statistically significant (p-value<0.05) effects compared to the respective negative control are noted with an asterisk (*).

FIG. 36A is a chart of breaker tomato weight results (N=36) for soil incorporated application of Valena and AKM at different rates and water statuses. Data is presented as the average±the standard error. Statistically significant (p-value<0.05) effects compared to the respective negative control are noted with an asterisk (*).

FIG. 36B is a chart of breaker tomato weight results (N=36) for top dressed application of Valena and AKM at different rates and water statuses. Data is presented as the average±the standard error. Statistically significant (p-value<0.05) effects compared to the respective negative control are noted with an asterisk (*).

FIG. 37A is a chart of breaker tomato shelf life stability results (N=36) for soil incorporated application of Valena and AKM at different rates and water statuses. Data is presented as the average±the standard error. Statistically significant (p-value<0.05) effects compared to the respective negative control are noted with an asterisk (*).

FIG. 37B is a chart of breaker tomato shelf life stability results (N=36) for top dressed application of Valena and AKM at different rates and water statuses. Data is presented as the average±the standard error. Statistically significant (p-value<0.05) effects compared to the respective negative control are noted with an asterisk (*).

FIG. 38A is a chart of red ripe tomato weight results (N=36) for soil incorporated application of Valena and AKM at different rates and water statuses. Data is presented as the average±the standard error. Statistically significant (p-value<0.05) effects compared to the respective negative control are noted with an asterisk (*).

FIG. 38B is a chart of red ripe tomato weight results (N=36) for top dressed application of Valena and AKM at different rates and water statuses. Data is presented as the average±the standard error. Statistically significant (p-value<0.05) effects compared to the respective negative control are noted with an asterisk (*).

FIG. 39A is a chart of red ripe tomato pH results (N=36) for soil incorporated application of Valena and AKM at different rates and water statuses. Data is presented as the average±the standard error. Statistically significant (p-value<0.05) effects compared to the respective negative control are noted with an asterisk (*).

FIG. 39B is a chart of red ripe tomato pH results (N=36) for top dressed application of Valena and AKM at different rates and water statuses. Data is presented as the average±the standard error. Statistically significant (p-value<0.05) effects compared to the respective negative control are noted with an asterisk (*).

FIG. 40A is a chart of red ripe tomato soluble solids results (N=36) for soil incorporated application of Valena and AKM at different rates and water statuses. Data is presented as the average±the standard error. Statistically significant (p-value<0.05) effects compared to the respective negative control are noted with an asterisk (*).

FIG. 40B is a chart of red ripe tomato soluble solids results (N=36) top dressed application of Valena and AKM at different rates and water statuses. Data is presented as the average±the standard error. Statistically significant (p-value<0.05) effects compared to the respective negative control are noted with an asterisk (*).

### DETAILED DESCRIPTION OF EMBODIMENTS

The present invention relates to methods for improving, protecting, and stimulating the growth of plants, including but not limited to using a whole cell Euglena gracilis or paramylon derivative (Kemin Mich., Valena®) as a plant biostimulant, which imparts a comparable nutritional profile to that of kelp meal. One key differentiator from kelp, however, is the carbohydrate storage molecule in E. gracilis is paramylon, which is long chains of unbranched beta-1,3-glucan. Kelp has mostly alginic acid and other carbohydrates with only a small fraction (2-5%) in the form of laminarin, a branched beta-1,3-glucan with some beta-1,6-glucan.

According to at least one embodiment of the present invention, applying whole cell Euglena gracilis significantly enhanced four metrics (stem height, lateral stem height, wet weight, and dry weight) of both geranium and vinca plants.

Another aspect of the present invention relates to application methods, including but not limited to applying whole cell Euglena gracilis by soil or drench applications. Both application methods showed enhanced growth over the negative control.

According to another aspect of the present invention, the biostimulant applications show efficacy at different application rates. Of the five rates of application described herein (0.007, 0.015, 0.15, 1.5, and 3.0 g/L) the lowest three frequently (0.007, 0.015, 0.15) prove significant over the negative control; however, the three low rates often do not show significance over each other. Accordingly, the present invention includes but is not limited to application rates 1.5 and 3.0 g/L, which proved superior to the bottom three rates and the negative control. For instance, in at least one embodiment, the application rate is at least 3.0 g/L, while in a second embodiment, the application rate is at least 1.5 g/L. In alternative embodiments the application rate ranges between 0.007 to 3.0 g/L, more specifically between 0.015 to 3.0 g/L, and most preferably between 0.15 and 1.5 g/L.

### Example 1

Materials and Methods

Materials.

Seeds of Geranium Horizon Red (Pelargonium×hortorum)(Catalog#1036429) and Vinca Cobra Red (Catharanthus roseus)(Catalog#561235) were purchased from Ball Seed Company (West Chicago, Ill.). A general purpose growing media, ProMix BX Biofungicide Mycorrhizae (Quakertown, Pa.), was used in all of the studies. Materials evaluated in this study included: Valena™ (Euglena gracilis, 50% beta-glucan, Item#017600, Lot 102616-AM-1, manufactured October 2016, Kemin Mich.).

Plug Trial.

Seeds of geranium and vinca were sown in 288-cell plug trays filled with ProMix or ProMix amended with dry formulations of Valena (Soil, Table 1). Following sowing, plug trays were wetted with clear water. Drench treatments were applied by suspending Valena at the appropriate treatment level and then applying on top of the soilless media (Drench, Table 1). Five different rates of Valena were evaluated (0.007, 0.015, 0.15, 1.5, and 3.0 mg/L of growing media) for each application. There were 11 different treatments performed in duplicate with 2 plant varieties giving 42 plug trays plus 1 additional control tray for each plant variety to carry into the pot trial (86 trays total). Each plug tray had 108 seeds centrally located on the tray to avoid edge effects (3 media-filled but unsewn cells around the entire tray) for a total of 4,644 sewn seeds (2,322 per species).

Plugs were grown in a corrugated plastic greenhouse with radiant heat, fan, and pad cooling. The day and night temperatures were set at 75° F. and 65° F., respectively. Plants were grown under ambient light intensities with no supplemental lighting and fertilized once (week 2) or twice (week 3-6) per week with 100 ppm N from water-soluble fertilizer (17-4-17) (Scotts brand).

TABLE 1
Plug Trial.

| Tray | | | Rate | | | Plant |
|---|---|---|---|---|---|---|
| # | Rep | Product | (g/L) | Application | Plant | # |
| 1 | A, B, C | None | None | None | Geranium | 324 |
| 2 | A, B | Valena | 0.007 | Soil | Geranium | 108 |
| 3 | A, B | Valena | 0.015 | Soil | Geranium | 108 |
| 4 | A, B | Valena | 0.15 | Soil | Geranium | 108 |
| 5 | A, B | Valena | 1.5 | Soil | Geranium | 108 |
| 6 | A, B | Valena | 3 | Soil | Geranium | 108 |
| 7 | A, B | Valena | 0.007 | Drench | Geranium | 108 |
| 8 | A, B | Valena | 0.015 | Drench | Geranium | 108 |
| 9 | A, B | Valena | 0.15 | Drench | Geranium | 108 |
| 10 | A, B | Valena | 1.5 | Drench | Geranium | 108 |
| 11 | A, B | Valena | 3 | Drench | Geranium | 108 |
| 22 | A, B, C | None | None | None | Vinca | 324 |
| 23 | A, B | Valena | 0.007 | Soil | Vinca | 108 |
| 24 | A, B | Valena | 0.015 | Soil | Vinca | 108 |
| 25 | A, B | Valena | 0.15 | Soil | Vinca | 108 |
| 26 | A, B | Valena | 1.5 | Soil | Vinca | 108 |
| 27 | A, B | Valena | 3 | Soil | Vinca | 108 |
| 28 | A, B | Valena | 0.007 | Drench | Vinca | 108 |
| 29 | A, B | Valena | 0.015 | Drench | Vinca | 108 |
| 30 | A, B | Valena | 0.15 | Drench | Vinca | 108 |
| 31 | A, B | Valena | 1.5 | Drench | Vinca | 108 |
| 32 | A, B | Valena | 3 | Drench | Vinca | 108 |

Plug Trial Metrics.

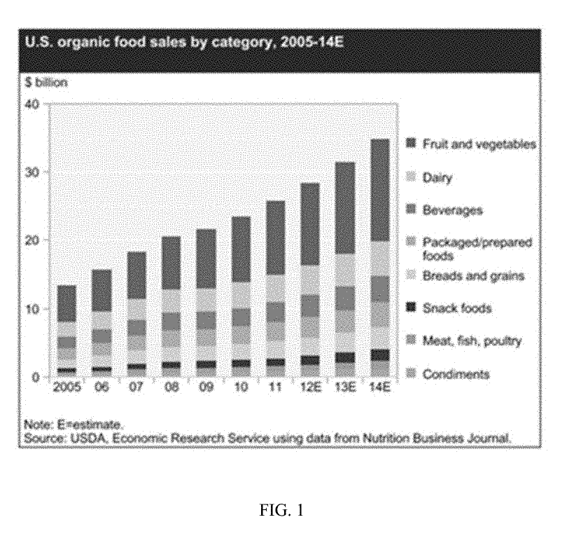

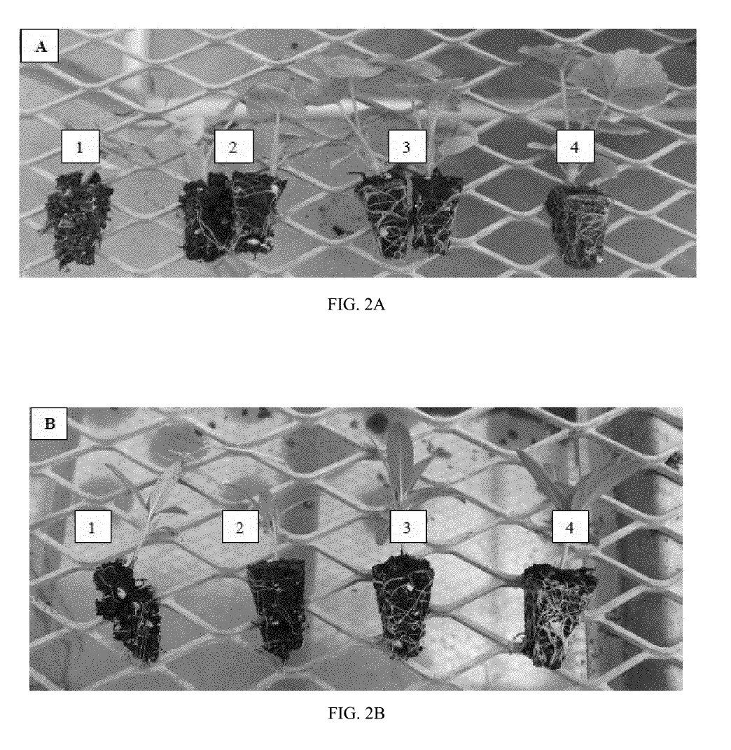

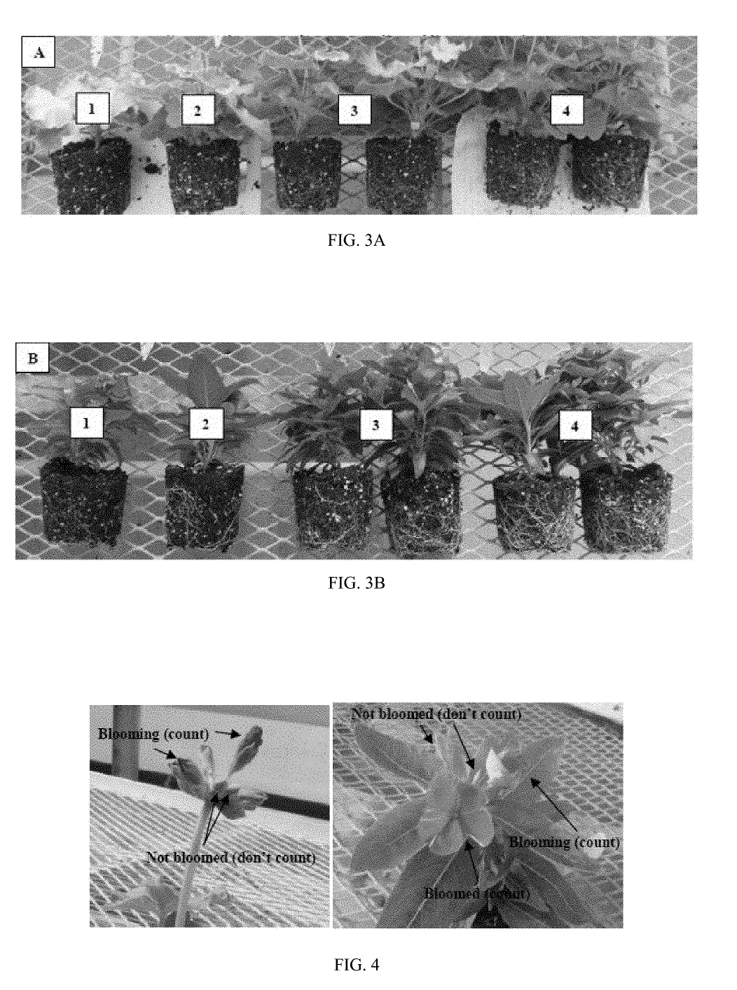

After 4 (geranium) to 6 (vinca) weeks, based on crop growth for a ‘finished’ plug, data was collected. Data collection included: 1) days to emergence; 2) plug stem height; 3) plug lateral stem height; 4) plant wet weight; 5) plant dry weight; and 6) plug root rating. Germination rate and days to emergence were determined using the date of seed sewing and date the hypocotyl emerged above the soil surface. Stem height was determined by measuring the length (mm) of the apical meristem of the plant from the base of the plant at the soil line. The lateral stem height was measured as the length (mm) of the tip of the tallest leaf petiole (geranium) or tallest leaf (vinca) to the base of the plant at the soil line. Plants were clipped at the soil line and weighted (g) to the nearest thousandth decimal point before (wet weight) and after drying (dry weight). Plants were dried using a food dehydrator set at 120° F. for 6 hr. The quality and density of the roots were scored visually using a 4-point scale (FIG. 1). Descriptively, a score of 1 indicates poorly formed or minimal roots with easy breakage of the plug upon handling; a score of 2 represents diffuse and/or <50% observable roots covering the plug with minor plug separation possible; a score of 3 represents 50-75% root coverage with no plug separation; and a score of 4 is 75% observable root coverage with a compact whole plug.

Pot Trial.

As a continuation from the plug trial, this experiment quantified the use of either Valena (Euglena gracilis, 50% beta-glucan) in liquid drench or incorporated into the media during the plug phase (Plug), finishing phase (Pot), or throughout both production phases compared to untreated in both phases (Table 2). Only one rate, 1.5 g/L, was applied for the respective treatment material and was based on the data from the plug trial. Treated and untreated growing media was prepared as equivalent to the plug trial and 4-inch pots were used. Thirty plants were potted up from the plug trial (15 plants from each replicate treatment or 10 from each replicate of negative control tray) for a total of 390 total pots (195 from each species). Plants were grown in a corrugated plastic greenhouse with radiant heat, fan, and pad cooling. The day and night temperatures were set at 75° F. and 65° F., respectively. Plants were grown under ambient light intensities with no supplemental lighting and fertilized 1-2 times per week with 200 ppm N from water-soluble fertilizer (17-4-17).

TABLE 2
Pot Trial.

| Treat- | | Pro- | Appli- | | | Plant | Plug |
|---|---|---|---|---|---|---|---|
| ment | Plant | duct | cation | Plug | Pot | # | Tray |
| 1 | Geranium | Control | None | Un- | Un- | 30 | 1 ABC |
| | | | | treated | treated | | |
| 2 | Geranium | Valena | Soil | Un- | Treated | 30 | 1 ABC |
| | | | | treated | | | |
| 3 | Geranium | Valena | Soil | Treated | Un- | 30 | 5 AB |
| | | | | | treated | | |
| 4 | Geranium | Valena | Soil | Treated | Treated | 30 | 5 AB |
| 5 | Geranium | Valena | Drench | Un- | Treated | 30 | 1 ABC |
| | | | | treated | | | |
| 6 | Geranium | Valena | Drench | Treated | Un- | 30 | 10 AB |
| | | | | | treated | | |
| 7 | Geranium | Valena | Drench | Treated | Treated | 30 | 10 AB |
| 14 | Vinca | Control | none | Un- | Un- | 30 | 22 |
| | | | | treated | treated | | ABC |
| 15 | Vinca | Valena | Soil | Un- | Treated | 30 | 22 |
| | | | | treated | | | ABC |
| 16 | Vinca | Valena | Soil | Treated | Un- | 30 | 26 AB |
| | | | | | treated | | |
| 17 | Vinca | Valena | Soil | Treated | Treated | 30 | 26 AB |
| 18 | Vinca | Valena | Drench | Un- | Treated | 30 | 22 |
| | | | | treated | | | ABC |
| 19 | Vinca | Valena | Drench | Treated | Un- | 30 | 31 AB |
| | | | | | treated | | |
| 20 | Vinca | Valena | Drench | Treated | Treated | 30 | 31 AB |

Pot Trial Metrics.

After 4 (geranium) to 7 (vinca) weeks, depending on crop growth and observation of ‘finished’ pot conditions, data was collected. Data collection included: 1) stem height; 2) lateral stem height; 3) plant wet weight; 4) plant dry weight; and 5) pot root rating. Plants were cut off from the soil line and respective metrics were measured as described in the plug trial. Wet plant samples were dried for 4 days in a freeze dryer.

Flowering Rate:

The date of flowering was recorded as the date a bloomed or blooming flower was noticed on a plant. A flower was recorded if the petals displayed signs of blooming and began to show distinct colors.

Results

Plug Trial.

The days to emergence and germination rate were evaluated for each plant species, treatment rate, and application method. Geranium did not show any difference between the negative control and any of the Valena (Euglena gracilis, 50% beta-glucan) treatment rates or application method except for at 1.5 and 3.0 g/L of Valena as a drench, which took one extra day before emergence was observed (FIG. 4A). Vinca overall showed a stronger effect with all the treatments and applications having a significant and slower emergence rate by as much as one day compared to the negative control (FIG. 4B).

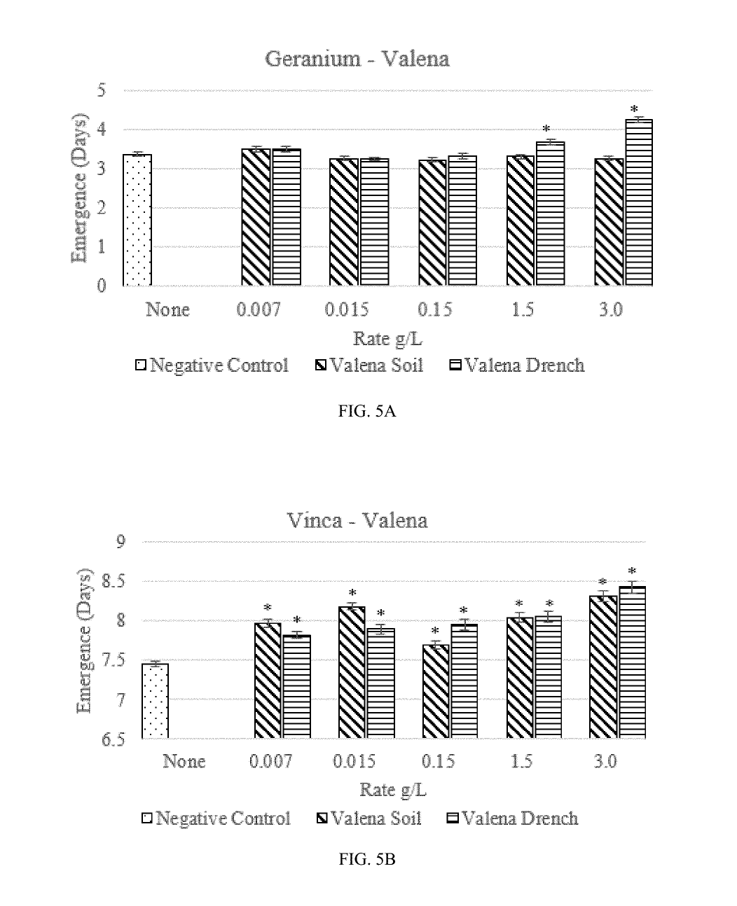

Stem height was found to be greater for both geranium and vinca for top dress drench of Valena at all of the treatment levels with the exception of 0.015 g/L level on vinca (FIG. 5). Soil application of Valena showed significantly increased stem growth only at 3 g/L for geranium. For vinca, all the tested rates except for 0.15 g/L had a significant impact on stem height.

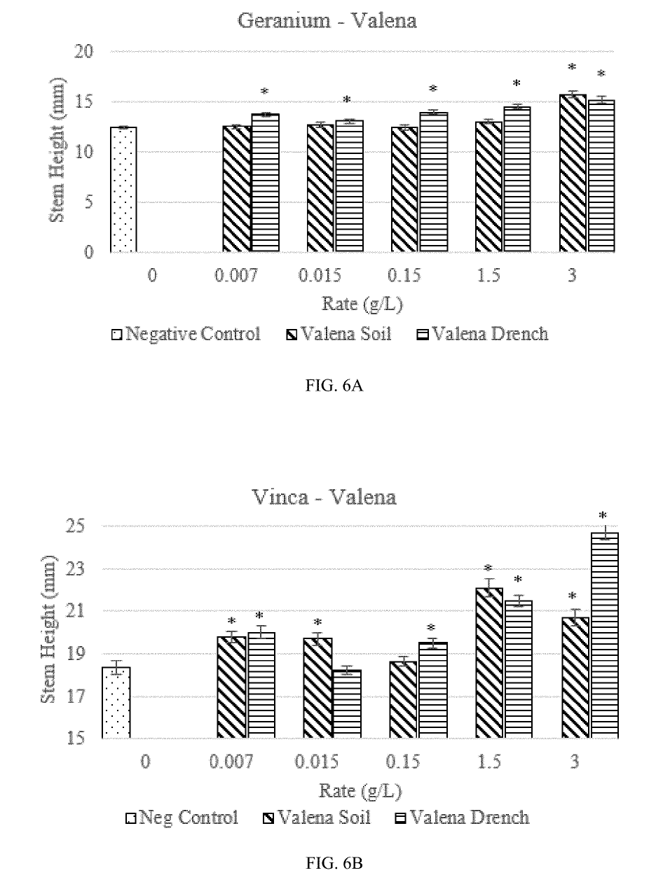

Valena application on geranium and vinca showed significant increase in lateral stem height at all treatment levels and application methods with exception of 0.15 g/L in soil and 0.015 drench on vinca (FIG. 6).

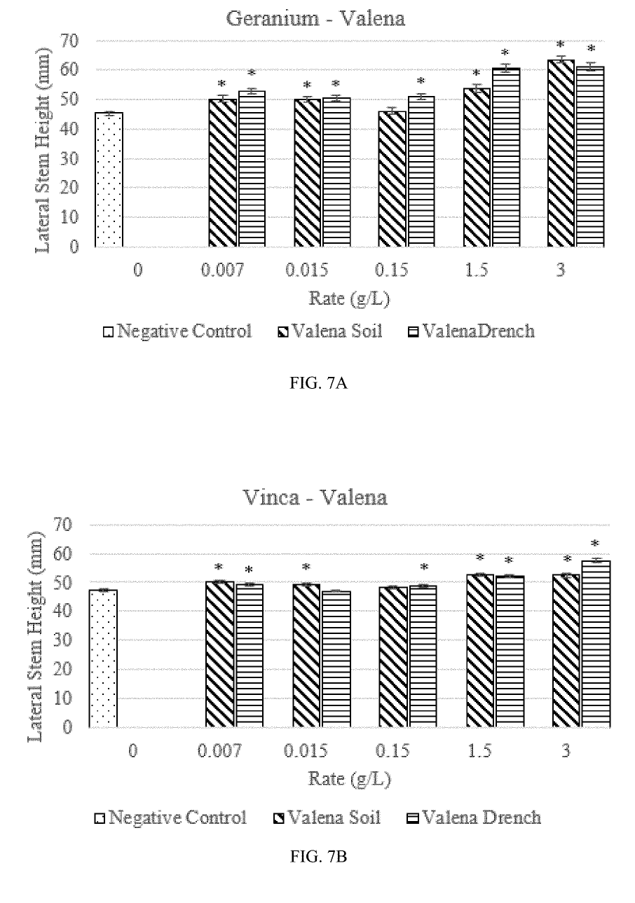

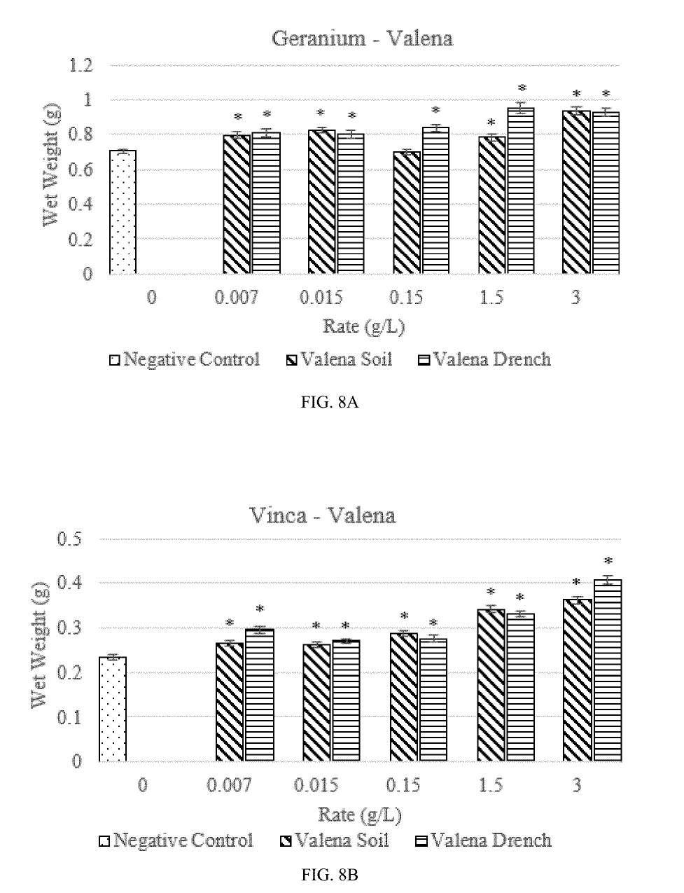

Treatment of geranium and vinca with Valena, either in the soil or as a drench, showed significant increase in wet weights for all treatment levels except for 0.15 g/L soil application for geranium (FIG. 7). The dry weight of the plug plants showed vinca to maintain the significant increase in biomass over the control at all levels and treatments except for 0.007 g/L soil application and the 0.015 drench application (FIG. 8B).

Upon drying, geranium did not maintain its significant mass differential over the negative control and only the treatments >0.15 g/L in drench application and 3.0 g/L soil application were significantly above the negative control.

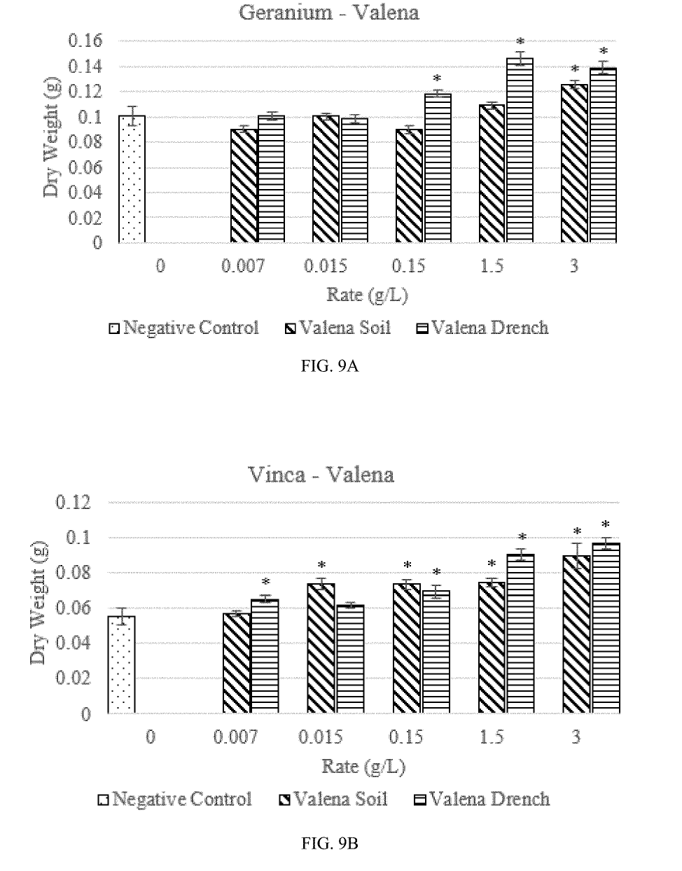

Root scores for geranium at all levels and application methods with Valena showed significant improvement over the negative control (FIG. 9A). Conversely, vinca showed only 1.5 g/L of Valena applied in a drench showed significant improvement in root score over the negative control (FIG. 9B).

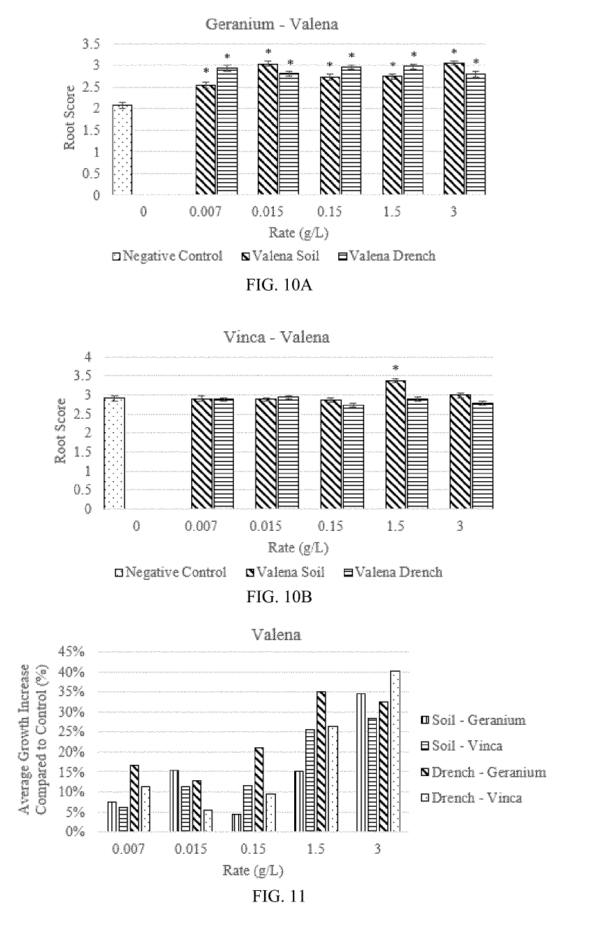

A comparison of percent change in each metric compared to the negative control for the plug trial showed that most metrics had a positive increase in a dose responsive manner (Table 3). When evaluating the average percent growth increase over the negative control it becomes more evident that the application of Valena at 1.5 g/L or higher provided consistently greater than 15% improvement if not greater than 25% for overall growth based on the metrics of this study (Table 3, FIG. 10).

TABLE 3
Percent change in metric as compared to the negative control for Valena
(Euglena gracilis, 50% beta-glucan) treatments applied either in the soilless medium (soil) or as
a watered in top dress (drench) for geranium and vinca grown in plug trays.
Geranium

| | Soil (g/L) | | | | | Drench (g/L) | | | | |
|---|---|---|---|---|---|---|---|---|---|---|
| | 0.007 | 0.015 | 0.15 | 1.5 | 3.0 | 0.007 | 0.015 | 0.15 | 1.5 | 3.0 |
| Stem Height | 1% | 2% | 0% | 5% | 27% | 11% | 6% | 13% | 17% | 23% |
| Lateral Stem | 11% | 11% | 1% | 18% | 40% | 16% | 11% | 13% | 34% | 35% |
| Height | | | | | | | | | | |
| Wet Weight | 13% | 17% | −1% | 11% | 33% | 15% | 14% | 19% | 35% | 32% |
| Dry Weight | −10% | 0% | −11% | 8% | 25% | 0% | −2% | 18% | 46% | 38% |
| Root Score | 23% | 47% | 32% | 32% | 47% | 41% | 36% | 42% | 44% | 35% |
| Average Growth | 7% | 15% | 4% | 15% | 34% | 17% | 13% | 21% | 35% | 33% |
| Difference | | | | | | | | | | |
| | Vinca | | | | | | | | | |
| | Soil (g/L) | | | | | Drench (g/L) | | | | |
| | 0.007 | 0.015 | 0.15 | 1.5 | 3.0 | 0.007 | 0.015 | 0.15 | 1.5 | 3.0 |
| Stem Height | 8% | 7% | 2% | 20% | 13% | 9% | −1% | 6% | 17% | 35% |
| Lateral Stem | 6% | 4% | 2% | 11% | 11% | 4% | −1% | 3% | 10% | 22% |
| Height | | | | | | | | | | |
| Wet Weight | 14% | 12% | 23% | 46% | 55% | 26% | 16% | 18% | 42% | 74% |
| Dry Weight | 3% | 33% | 32% | 34% | 61% | 17% | 11% | 25% | 63% | 75% |
| Root Score | 0% | −1% | −1% | 16% | 3% | −1% | 1% | −6% | −1% | −4% |
| Average Growth | 6% | 11% | 12% | 26% | 28% | 11% | 5% | 9% | 26% | 40% |
| Difference | | | | | | | | | | |

Pot Trial.

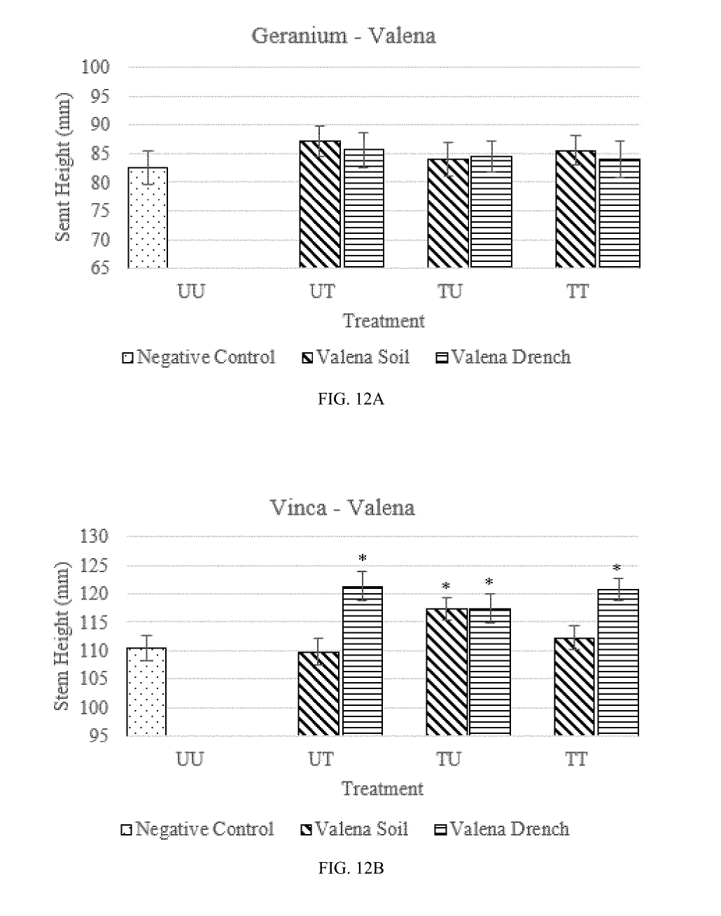

A cross-over design for evaluation of Valena after one or two treatments at the 1.5 g/L treatment level showed less impact on the final plant metrics in this trial, respectively. The stem height for geranium showed a trend for increase height but not statistically significant (FIG. 11A). The vinca did show significance for all three treatment designs when applied in a drench, whereas the soil application only showed significant increase for the treated plug/untreated pot (TU) (FIG. 11B). Similarly, the lateral stem height showed significance for only the treated plug/treated pot (TT) in the geranium, but showed significance from all treatment applications and designs except for UT and TT for soil application on vinca (FIG. 12).

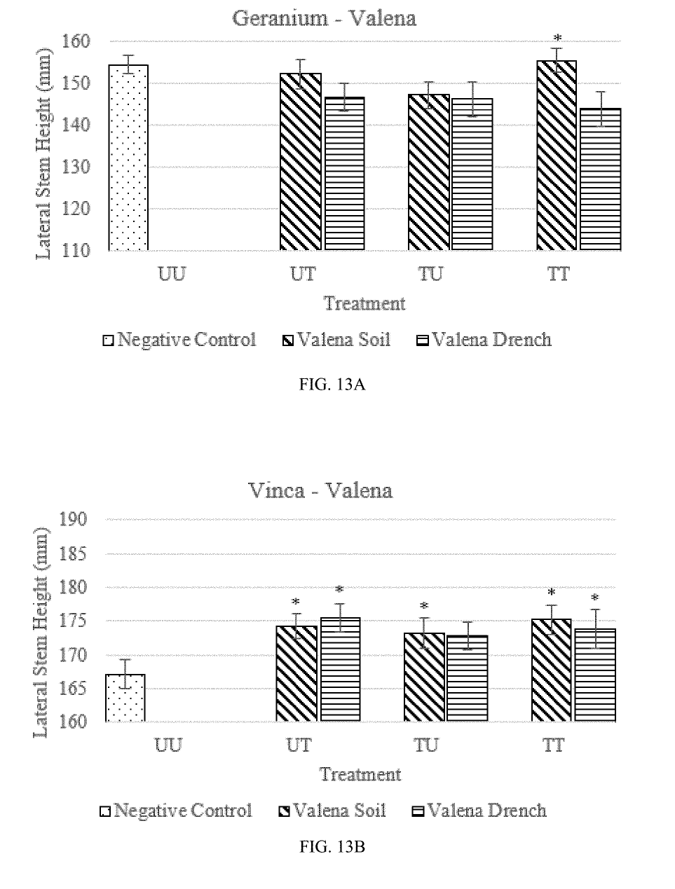

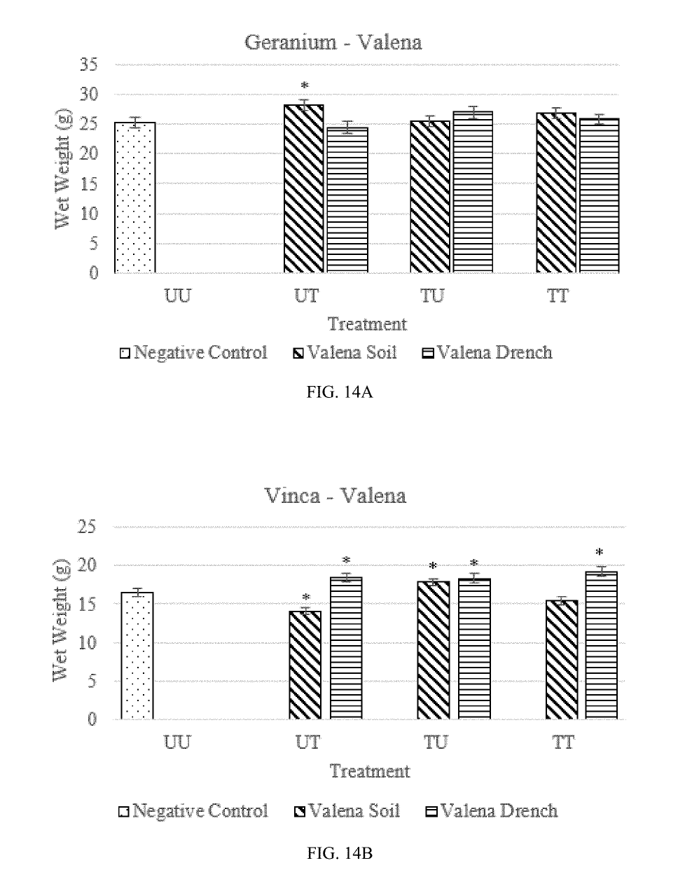

Wet weight of geraniums showed generally no major difference between negative control and treatments, but one exception of untreated plugs/treated pots (UT) showed significantly higher wet biomass (FIG. 13A). The vinca showed increased wet weights for all drench applications. The soil applications showed a split based on the design with UT having significantly lower wet weight but the TU having increased wet weight compared to the negative control (FIG. 13B). Interestingly, the dry weights for both geranium and vinca were not significantly different from the negative control and were considered homogeneous for both the application and the design (FIG. 14).

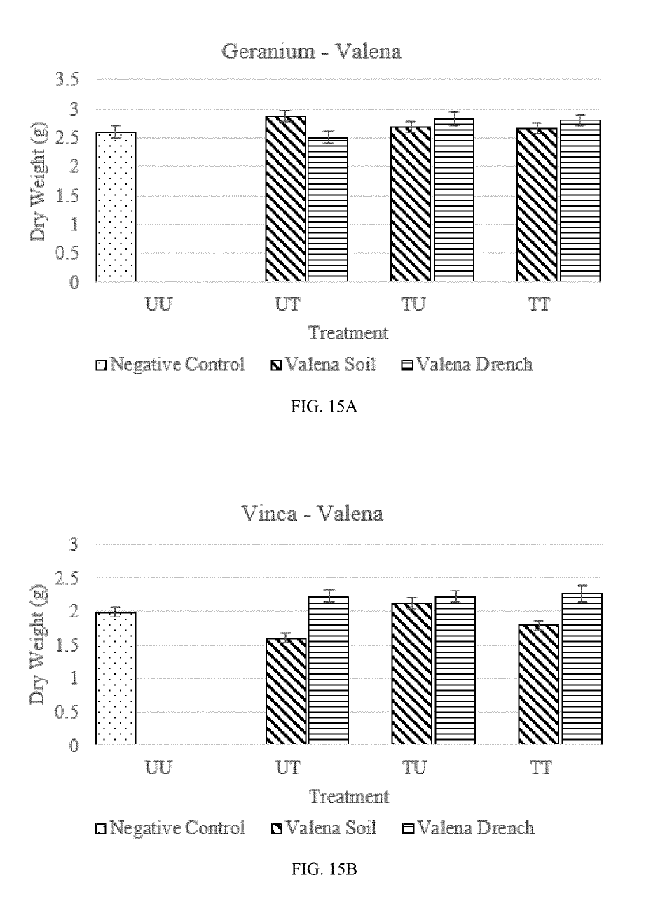

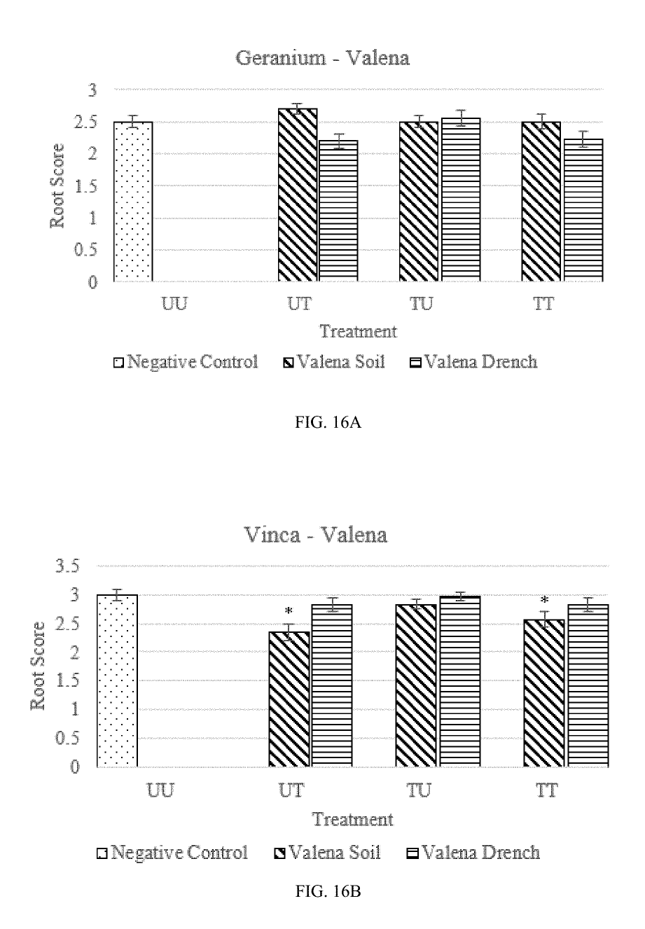

Overall root scores were not significantly different from the negative control for geranium and most of the treatments for vinca (FIG. 15). The vinca exceptions were significantly lower in root score for the soil application to UT and TT treatments (FIG. 15B). The days to flowering also did not show any distinction between treatment or design for either plant (FIG. 16).

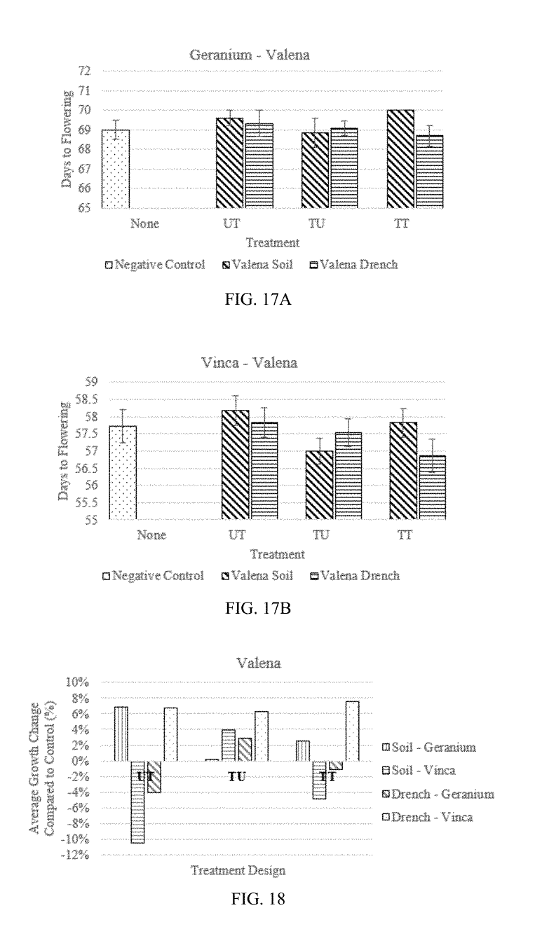

A comparison of percent change in each metric for the pot trial showed mixed and respectively minor (<10%) differences from the negative control (Table 4). For geranium, the soil application had a stronger impact and interestingly, the application in the pot phase only showed a stronger growth impact than when both plug and pot phases were treated. When evaluating the average percent growth increase over the negative control it becomes more evident that the application of Valena at 1.5 g/L as a drench at any time of incorporation (plug or pot) on vinca was beneficial (Table 4, FIG. 17).

TABLE 4
Percent change in metric as compared to the negative control
for Valena (Euglena gracilis, 50% beta-glucan) treatments
applied either only at the plug phase (UT), the
pot phase (TU), or both plug and pot phase (TT) in the
soilless medium (soil) or as a watered in
top dress (drench) for geranium and vinca grown to finish.

| | Geranium | | | | | |
|---|---|---|---|---|---|---|
| | Soil (1.5 g/L) | | | Drench (1.5 g/L) | | |
| | UT | TU | TT | UT | TU | TT |
| Stem Height | 6% | 2% | 4% | 4% | 2% | 2% |
| Lateral Stem Height | −1% | −5% | 1% | −5% | −5% | −7% |
| Wet Weight | 12% | 0% | 6% | −3% | 7% | 2% |
| Dry Weight | 10% | 4% | 3% | −4% | 9% | 8% |
| Root Score | 8% | 0% | 0% | −12% | 2% | −11% |
| Average Growth | 7% | 0% | 3% | −4% | 3% | −1% |
| Difference | | | | | | |
| | Vinca | | | | | |
| | Soil (1.5 g/L) | | | Drench (1.5 g/L) | | |
| | UT | TU | TT | UT | TU | TT |
| Stem Height | −1% | 6% | 2% | 10% | 6% | 9% |
| Lateral Stem Height | 4% | 4% | 5% | 5% | 3% | 4% |
| Wet Weight | −15% | 8% | −6% | 12% | 11% | 16% |
| Dry Weight | −19% | 7% | −10% | 12% | 12% | 14% |
| Root Score | −22% | −6% | −14% | −6% | −1% | −6% |
| Average Growth | −10% | 4% | −5% | 7% | 6% | 8% |
| Difference | | | | | | |

Results of the plug trial confirmed that applications of Valena significantly enhanced four metrics (stem height, lateral stem height, wet weight, and dry weight) of both geranium and vinca plants. The root scores appeared to be specific to the plant speciesand showed significance for all treatments for geranium but only one treatment level and application showed significant improvement over the negative control treatment for vinca. Interestingly, Valena showed a delayed emergence time; however, the amount of time, one day or less, may not be economically significant. Both application methods, by soil or drench application, show enhanced growth over the negative control. The rate of application of the biostimulant also impacted the results. Of the five rates of application (0.007, 0.015, 0.15, 1.5, and 3.0 g/L) the three lowest rates (0.007, 0.015, 0.15) were shown to be significant over the negative control; however, the three low rates often do not show significance over each other. Plugs of geranium are more likely to show significance over the negative control at the lower rates compared to vinca plugs, which trend more towards no significance over the negative control at the three low rates. Application rates 1.5 and 3.0 g/L were superior to the three lowest rates and the negative control. An application rate of 3.0 g/L typically displays significance over 1.5 g/L; however, several instances exist in which there is no significant difference between the top two rates. Other metrics, as well, indicate that whatever significance exists between the top two rates, on average, does not reflect a twofold increase in plant growth; however, it is important to note that the maximum treatment level in which growth either plateaued or dropped was not observed.

Results of the pot trial revealed less overall significance than the plug trial. Pots of geranium showed, on average, no significant improvements for any metric. The geranium pots also suffered from trace metal deficiency due to hot environmental conditions. The vinca pots, on the other hand, did show significant improvement for all metrics except root rating and flowering dates. Pots that were treated with the Valena twice (TT) did not show superiority in the final metrics over control plugs treated with the Valena (UT) nor treated plugs that were not subjected to additional Valena applications (TU).

Though the effect was more profoundly observed in the smaller, rapidly growing plugs, the effect for the pots also demonstrated increased growth in some metrics. Even with a single application at each phase, plug and/or pot, the work here demonstrates that Valena is acting as a biostimulant to enhance the growth of the plants.

### Example 2

Materials and Methods

All seeds were purchased from Ball Seed Company (West Chicago, Ill.) and included tomato (Solanum lycopersicum, Bush Early Girl), bell pepper (Capsicum anuum, Better Belle II), melon (Cucumis melo, Melon Ball 2076), impatiens (Impatiens walleriana), and vinca (Catharanthus roseus, Vinca Cobra Mint). Three different lots of dry, dead, whole cell Euglena gracilis that ranged in paramylon content from 52-62% and a lot of 95% paramylon were used in the evaluations (Table 5). Two competitor positive controls, AKM and IA, were evaluated for comparison.

TABLE 5
Euglena gracilis and paramylon material
lots evaluated in this study.

| Material | 1,3-beta-glucan | Lot # |
|---|---|---|
| Euglena - low level paramylon | 52% | MA55 |
| Euglena - mid level paramylon | 59% | 1709107928 |
| Euglena - high level paramylon | 62% | 1709108063 |
| Paramylon | 95.8% | 061116-BG-1 |

Treatment material was weighed out and suspended in 100 ml of Milli-Q water. For the Euglena gracilis treatments, 0.15 g was used in the suspensions. For paramylon, three different rates were evaluated which were equivalent to the low, medium, and high amounts of paramylon present in the E. gracilis lots (0.081 g, 0.092 g, and 0.097 g, respectively). Competitor positive controls, IA and AKM, were added at 400 μl and 0.15 g per 100 ml of Milli-Q water, respectively. Negative control treatment was only Milli-Q water. Sixty-four seeds were added to the respective treatment suspension and allowed to soak for 10 min at room temperature (22-25° C.) before pouring the suspension through a coffee filter to drain. Seeds were then placed on a moistened (5 ml of Milli-Q water) Whatman Grade 4 filter inside a 150-mm petri dish. The petri dish was sealed with parafilm and placed in the dark at 25° C. Seeds were monitored daily to measure days to germination. The seedling mesocotyledon (leads to shoot) length, radicle (root) length, and root hair score were measured for 20 random seedlings in each petri dish one week after the seeds were treated and incubated. Impatiens did not show any differentiation in the root hair development and was omitted from root scoring. All treatments were conducted in triplicate. One-way analysis of variance (ANOVA) via StatGraphics® Centurion XV (Warrenton, Va.) was used to analyze the data for significance (p<0.05).

Germination.

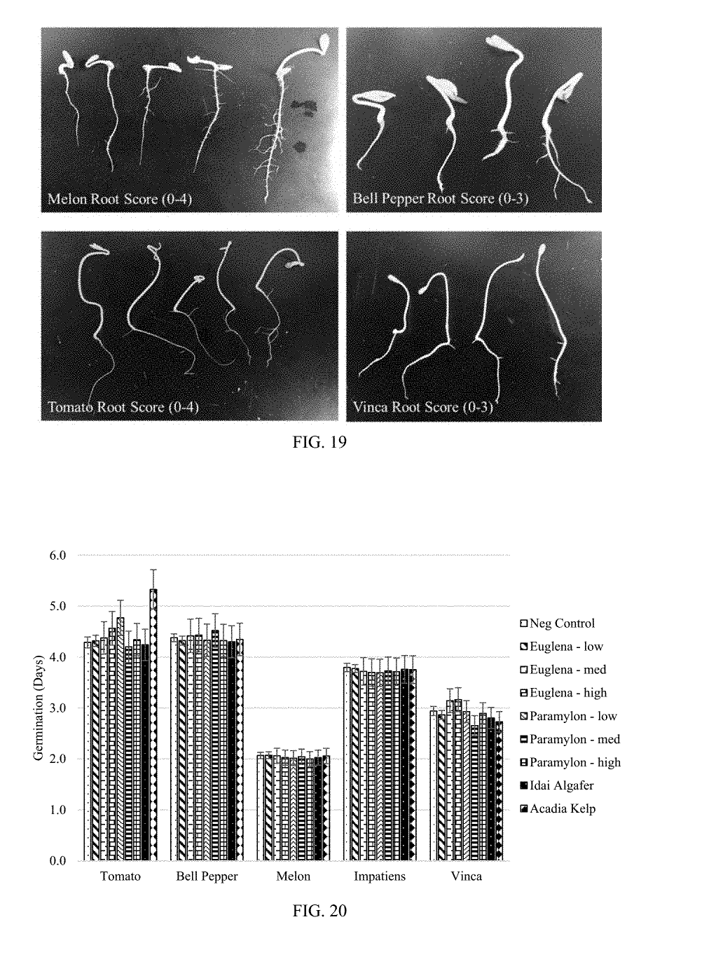

All of the seeds showed percent germination within range of the manufacturer's guarantee for each of the respective plant species. Depending on treatment, there was some slight variation but no distinguishable trend for germination percent with tomatoes having 95-98%, bell peppers having 91%-96%, melon having 95-98%, impatiens having 97-98%, and vinca having 93-96% germination of seeds (Table 6). Looking at days to germination, none of the evaluated plants showed a significant difference compared to the negative control except for the treatments of paramylon at the low rate and AKM in tomato which showed a longer time to germinate while paramylon at the medium rate in vinca showed a shortened time to germinate (FIG. 19 and Table 7).

TABLE 6
Percent germination of treated seeds.

| Treatment | Tomato | Bell Pepper | Melon | Impatiens | Vinca |
|---|---|---|---|---|---|
| Neg Control | 97% | 91% | 98% | 98% | 96% |
| Euglena - low | 95% | 94% | 98% | 98% | 95% |
| Euglena - med | 97% | 92% | 98% | 97% | 93% |
| Euglena - high | 98% | 93% | 96% | 98% | 93% |
| Paramylon - low | 97% | 95% | 96% | 98% | 95% |
| Paramylon - med | 95% | 96% | 95% | 97% | 93% |
| Paramylon - high | 95% | 95% | 96% | 98% | 95% |
| IA | 96% | 96% | 96% | 98% | 94% |
| AKM | 97% | 95% | 96% | 98% | 95% |

TABLE 7
Statistical significance of treatments on days to germination
as compared to the negative control. Each letter represents
a homogenous group. Treatments that do not have overlapping
letters are significant from each other.

| Treatment | Tomato | Bell Pepper | Melon | Impatiens | Vinca |
|---|---|---|---|---|---|
| Neg Control | ab | ab | a | a | bc |
| Euglena - low | ab | ab | a | a | ab |
| Euglena - med | ab | ab | a | a | c |
| Euglena - high | bc | ab | a | a | c |
| Paramylon - low | c | ab | a | a | bc |
| Paramylon - med | a | b | a | a | a |
| Paramylon - high | ab | ab | a | a | ab |
| Idai Algafer | a | a | a | a | ab |
| AKM | d | ab | a | a | ab |

Mesocotyl Length.

All of the treatments showed significantly shorter mesocotyl lengths compared to the negative control with exception of paramylon at the medium and high application rates in both tomatoes and bell peppers (FIG. 20 and Table 8). Both the IA and AKM were significantly shorter for mesocotyl length in tomatoes even as compared to the E. gracilis and paramylon treatments. In melon, the medium E. gracilis treatment showed significantly reduced mesocotyl length while all other treatments were not significantly different. In impatiens, the AKM showed increased length. In vinca, none of the treatments showed different mesocotyl lengths from that of the negative control.

TABLE 8
Statistical significance of treatments on seedling mesocotyl
length compared to the negative control. Each letter represents
a homogenous group. Treatments that do not have overlapping
letters are significant from each other.

| Treatment | Tomato | Bell Pepper | Melon | Impatiens | Vinca |
|---|---|---|---|---|---|
| Neg Control | de | e | bcd | ab | ab |
| Euglena - low | bc | ab | ab | b | b |
| Euglena - med | bc | abc | a | b | a |
| Euglena - high | bc | a | bcd | b | ab |
| Paramylon - low | b | bc | bc | ab | ab |
| Paramylon - med | cd | de | d | bc | ab |
| Paramylon - high | e | de | bc | ab | a |
| IA | a | cd | bc | a | ab |
| AKM | a | ab | cd | c | ab |

Radicle Length.

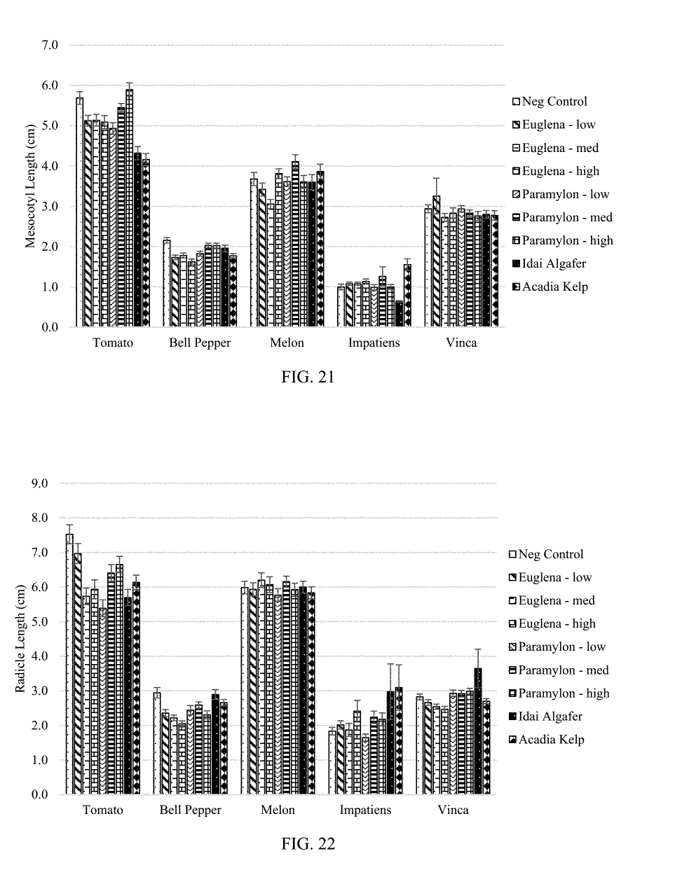

Only the E. gracilis at the low application rate showed similarity to the negative control in tomatoes (FIG. 21 and Table 9). All other treatments in tomatoes showed a significantly lower radicle length as compared to the negative control. Similarly, all of the E. gracilis and paramylon treatments were significantly lower in bell peppers, but the IA and AKM were comparable to the negative control. Melon and vinca showed no significant differences between the treatments for the radicle length while impatiens showed only the AKM as having significantly longer radicle length as compared to the negative control. The average radicle length for IA in impatiens and vinca was higher; however, the variation between replicates resulted in there being no significance between the negative control.

TABLE 9
Statistical significance of treatments on seedling radicle
length compared to the negative control. Each letter represents
a homogenous group. Treatments that do not have overlapping
letters are significant from each other.

| Treatment | Tomato | Bell Pepper | Melon | Impatiens | Vinca |
|---|---|---|---|---|---|
| Neg Control | f | f | a | ab | a |
| Euglena - low | ef | bc | a | ab | a |
| Euglena - med | abc | ab | a | a | a |
| Euglena - high | abc | a | a | abc | a |
| Paramylon - low | a | bcd | a | a | a |
| Paramylon - med | cde | cde | a | abc | a |
| Paramylon - high | de | abc | a | abc | a |
| IA | ab | ef | a | bc | b |
| AKM | bcd | def | a | c | a |

Root Hair Score.

The E. gracilis treatments at the medium and high rates as well as the paramylon at the low and medium rates showed significant increases in the root hair scores over the negative control, with the medium E. gracilis having the highest score in tomatoes (FIG. 21 and Table 10). AKM was a close second for the highest root hair score in tomatoes. Bell peppers only showed significance for E. gracilis at the medium rate; however, the root hair score was less than the negative control. All other treatments in bell peppers were comparable to the negative control. Melon showed no significance between the treatments and the negative control. Similarly, vinca showed no significance for any treatments with the exception of IA which was lower for root hair score.

TABLE 10
Statistical significance of treatments on seedling root
hair scores compared to the negative control. Each letter
represents a homogenous group. Treatments that do not have
overlapping letters are significant from each other.

| Treatment | Tomato | Bell Pepper | Melon | Vinca |
|---|---|---|---|---|
| Neg Control | a | b | ab | bc |
| Euglena - low | ab | ab | ab | abc |
| Euglena - med | d | a | a | abc |
| Euglena - high | bc | ab | a | abc |
| Paramylon - low | bc | ab | ab | c |
| Paramylon - med | bc | b | ab | abc |
| Paramylon - high | ab | b | ab | ab |
| IA | a | b | ab | a |
| AKM | c | ab | b | ab |

Different rates of the E. gracilis and paramylon did not show linear trends with increased amounts of paramylon nor were there consistent trends between the seedling metrics. The reduced mesocotyl and radicle lengths indicate that there may be some growth stunting to select seedling varieties as they are initially getting started; however, the percent germination was not affected. This small amount of stunting is rapidly overcome as we have observed the outgrowth of seedlings in plug trays to exceed the growth of untreated controls. For the E. gracilis and paramylon-based materials, it is possible that the observed stunting is indicative of plant biostimulation, and that the seedlings are rerouting resources to upregulate its immunity based on a perceived pathogenic attack [1-4]. The later increased growth makes up for the lag in initial seedling growth and development. There was observable significance in the E. gracilis and paramylon treatments for root score development and supports that these materials are acting as biostimulants even in the limited exposure time at the seedling stage.

### Example 3

Materials and Methods

Plug Trial.

Tomato (Solanum lycopersicum, Bush Early Girl) and impatiens (Impatiens walleriana) seeds were purchased from Ball Seed Company (West Chicago, Ill.). An all-purpose growing media, Berger BM6 (Hummert International, Earth City, Mo.), was used throughout the trial. Growing media was treated with Valena (Rates 1.8-28.8 g/l growing media, Kemin Agrifoods North America (KANA), Des Moines, Iowa), AKM (positive competitor control, 3.6 g/l growing media), or IA (positive competitor control, 9.5 ml/l growing media). Treatments were all mixed into the media. Tomato and impatiens seeds were hand sown into each 96 well flat and grown in a corrugated plastic greenhouse with radiant heat and fans. This trial was started mid-November and ended the last week of December. The day and night temperatures were set at 75° F. and 65° F., respectively, and grown under ambient light intensities with no supplemental lighting. Plants were watered twice daily until emergence, then drought-stressed plants were only watered half as often for the duration of the trial. Table 11 shows the whole plug trial design.

TABLE 11
Plug Trial Design.

| | | Inclusion | | | | |
|---|---|---|---|---|---|---|
| Plant | Treat- | Rate | Water | Plugs/ | | Total |
| Variety | ment | (g/l) | Status | Flat | Replicate | Plugs |
| Tomato | Neg | 0 | Water | 96 | 3 | 288 |
| | Control | | | | | |
| Tomato | Valena | 1.8 | Water | 96 | 3 | 288 |
| Tomato | Valena | 3.6 | Water | 96 | 3 | 288 |
| Tomato | Valena | 7.2 | Water | 96 | 3 | 288 |
| Tomato | Valena | 14.4 | Water | 96 | 3 | 288 |
| Tomato | Valena | 28.8 | Water | 96 | 3 | 288 |
| Tomato | IA | 9.6 ml/l | Water | 96 | 3 | 288 |
| Tomato | AKM | 3.6 | Water | 96 | 3 | 288 |
| Tomato | Neg | 0 | Drought | 96 | 3 | 288 |
| | Control | | | | | |
| Tomato | Valena | 1.8 | Drought | 96 | 3 | 288 |
| Tomato | Valena | 3.6 | Drought | 96 | 3 | 288 |
| Tomato | Valena | 7.2 | Drought | 96 | 3 | 288 |
| Tomato | Valena | 14.4 | Drought | 96 | 3 | 288 |
| Tomato | Valena | 28.8 | Drought | 96 | 3 | 288 |
| Tomato | IA | 9.6 ml/l | Drought | 96 | 3 | 288 |
| Tomato | AKM | 3.6 | Drought | 96 | 3 | 288 |
| Impatiens | Neg | 0 | Water | 96 | 3 | 288 |
| | Control | | | | | |
| Impatiens | Valena | 1.8 | Water | 96 | 3 | 288 |
| Impatiens | Valena | 3.6 | Water | 96 | 3 | 288 |
| Impatiens | Valena | 7.2 | Water | 96 | 3 | 288 |
| Impatiens | Valena | 14.4 | Water | 96 | 3 | 288 |
| Impatiens | Valena | 28.8 | Water | 96 | 3 | 288 |
| Impatiens | IA | 9.6 ml/l | Water | 96 | 3 | 288 |
| Impatiens | AKM | 3.6 | Water | 96 | 3 | 288 |
| Impatiens | Neg | 0 | Drought | 96 | 3 | 288 |
| | Control | | | | | |
| Impatiens | Valena | 1.8 | Drought | 96 | 3 | 288 |
| Impatiens | Valena | 3.6 | Drought | 96 | 3 | 288 |
| Impatiens | Valena | 7.2 | Drought | 96 | 3 | 288 |
| Impatiens | Valena | 14.4 | Drought | 96 | 3 | 288 |
| Impatiens | Valena | 28.8 | Drought | 96 | 3 | 288 |
| Impatiens | IA | 9.6 ml/l | Drought | 96 | 3 | 288 |
| Impatiens | AKM | 3.6 | Drought | 96 | 3 | 288 |
| Total | | | | | | 9,216 |

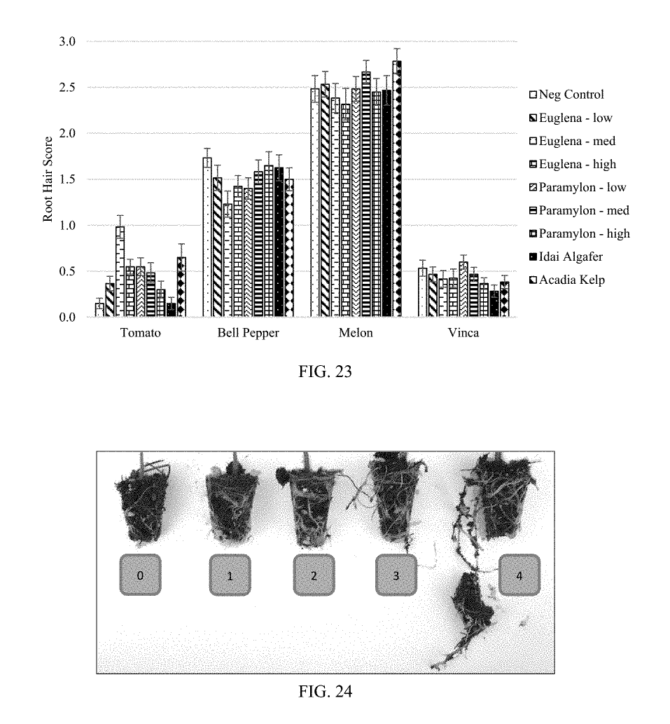

Fifty plants from each flat were measured for stem height (cm), lateral stem height (cm), root score (FIGS. 23 and 24), wet weight (g), and dry weight (g) (N=150). After four and six weeks, respectively, tomatoes and impatiens were processed and measured for growth parameters. Fifty plugs from each 96-well tray were taken out individually and roots were scored. Descriptively, a score of 0 indicates minimally formed roots that break easily and do not hold media together; a score of 1 indicates diffuse and/or <25% observable roots covering the plug with some media separation; a score of 2 indicates 25-50% root coverage with minimal media separation; a score of 3 indicates 50-75% root coverage with no media separation; and a score of 4 indicates >75% observable root coverage with no media separation. After root scoring, the plant was clipped with scissors at the base of the plant above the growing media. Plants were measured from the base to the tip for stem height (cm) and from the base to the tip of the top leaf for lateral stem height (cm). Wet weights (g) were measured by massing the clipped whole plant. Ten plants (of corresponding treatment rate and water status) were placed in a brown paper sack and placed in a freeze drier for 48 hours. Dry weights were measured for each individual plant and recorded. StatGraphics® Centurion XV (Warrenton, Va.) was used for statistical analysis of the compiled data. One-way analysis of variance (ANOVA) was performed for each of the metric data sets.

Results

Metrics.

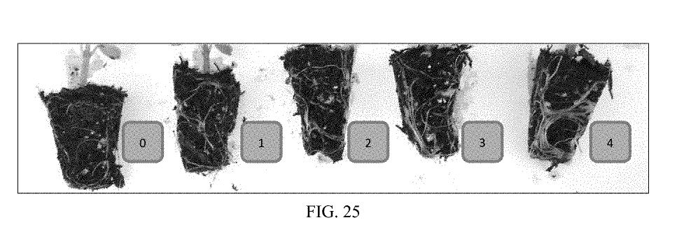

FIG. 25 shows the stem height results for tomatoes (FIG. 25A) and impatiens (FIG. 25B) for the respective rates. Stem heights for treatments and positive controls ranged from 4.6 to 9.5 cm while the negative control showed 3.9 and 4.4 cm for watered and drought stressed, respectively. There was a linear increase in stem height with increasing treatment rate of Valena for the tomatoes both watered and drought stressed. For impatiens average stem heights, Valena treatments ranged 1.6 to 2.7 cm, with negative controls at 1.7 and 1.8 cm for the watered and drought stressed plants, respectively. The average stem height for the impatiens positive controls were shorter than the negative control. All Valena treatments for the tomatoes and impatiens were significant in stem height over the negative control except the drought stressed impatiens treatments at 3.6 g/L Valena.

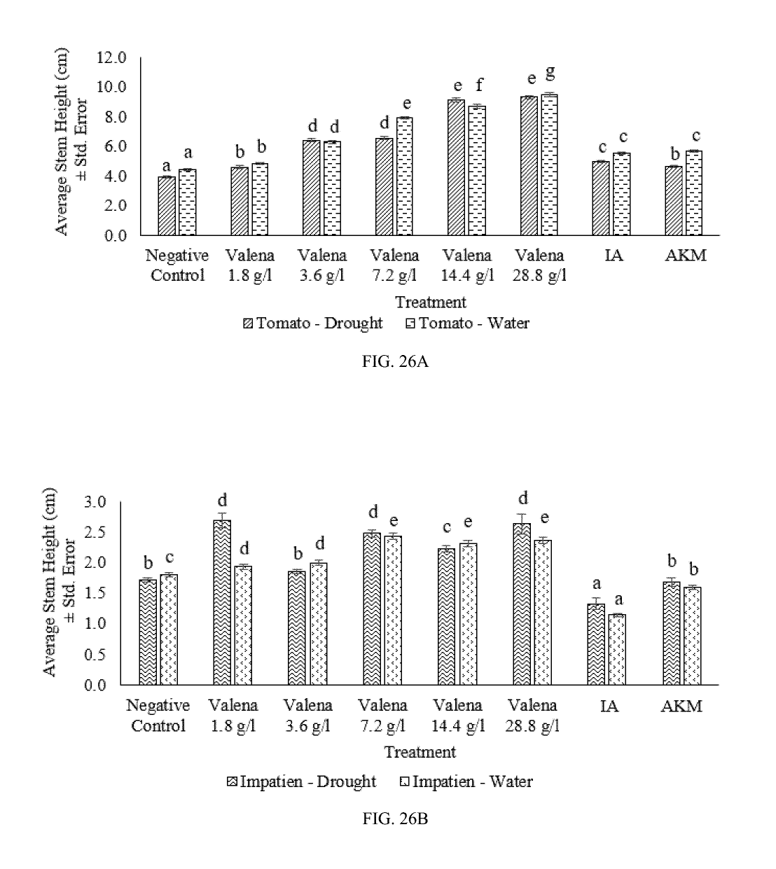

FIG. 26 shows the lateral stem height results for tomatoes (FIG. 26A) and impatiens (FIG. 26B) for the respective rates. Lateral stem heights for treatments and positive controls ranged from 3.5 to 6.6 cm while the negative control was 3.0 and 3.4 cm for the watered and drought stressed plants, respectively. There was a linear increase and significance in lateral stem height with increasing treatment rate of Valena for the tomatoes both watered and drought stressed. For impatiens, Valena treatments ranged 1.6 to 3.1 cm while the negative control was 2.3 and 2.6 cm for the watered and drought stressed plants, respectively. The positive controls for the impatiens were shorter than the negative controls for lateral stem height. All Valena treatments for the impatiens were significant in lateral stem height over the negative control except the drought stressed treatments at 1.8 g/L and 3.6 g/L Valena.

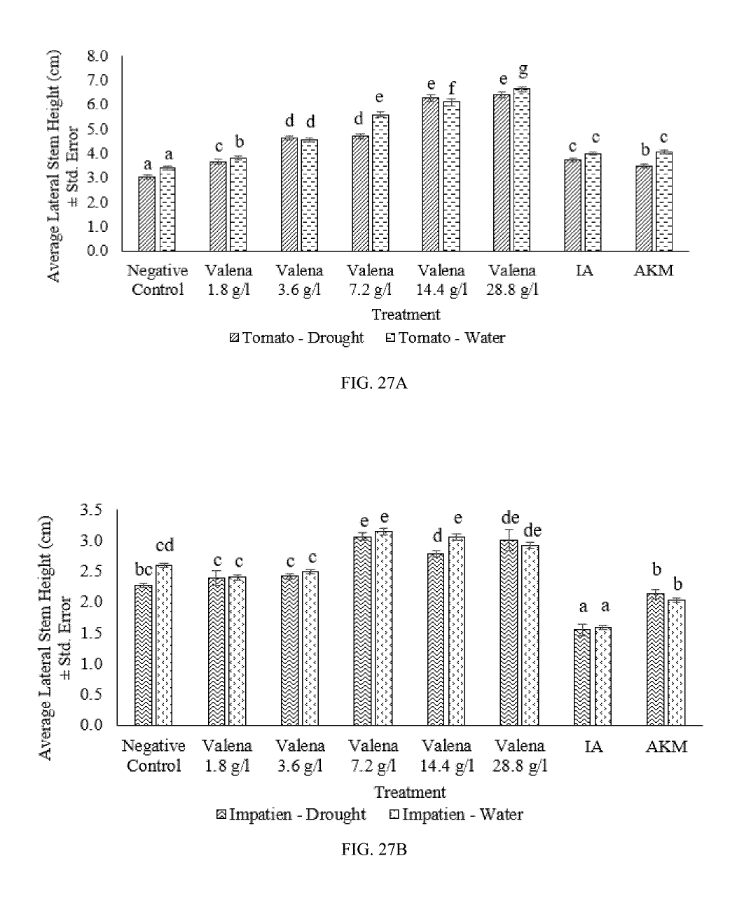

Wet weight results for tomatoes (FIG. 27A) and impatiens (FIG. 27B) showed a linear increase in with increasing Valena treatment rate. The positive controls were lower than the negative controls for both plant varieties. Tomatoes treated with Valena ranged from 0.15 to 0.53 g and impatiens ranged from 0.73 to 1.44 g. The negative control average wet weight for watered tomatoes was 0.15 g and the drought stressed tomatoes was 0.12 g. For impatiens, the watered negative control was 0.64 g and the drought stressed negative control was 0.67 g. All Valena treatments for the tomatoes and impatiens were significant in wet weight over the negative control except the drought stressed impatiens treatments at 3.6 g/L Valena.

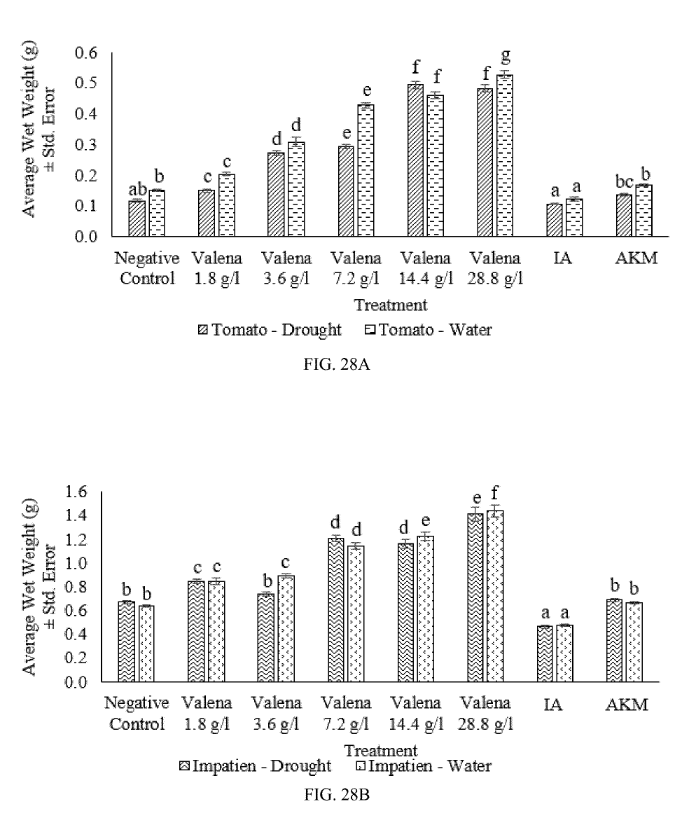

Dry weight results showed similar trends to the wet weight results (FIG. 28). Valena treated tomatoes showed strong significant linear mass increase and ranged from 0.035 to 0.104 g while the watered negative control was 0.029 g and drought stressed negative control was 0.022 g (FIG. 28A). The impatiens treated with Valena also showed a linear and significant increase in dry weight and ranged from 0.059 to 0.121 g while the watered negative control was 0.058 g and the drought stressed negative control was 0.053 g (FIG. 28B). The positive controls were equivalent or lower than the negative control for both plants and water statuses.

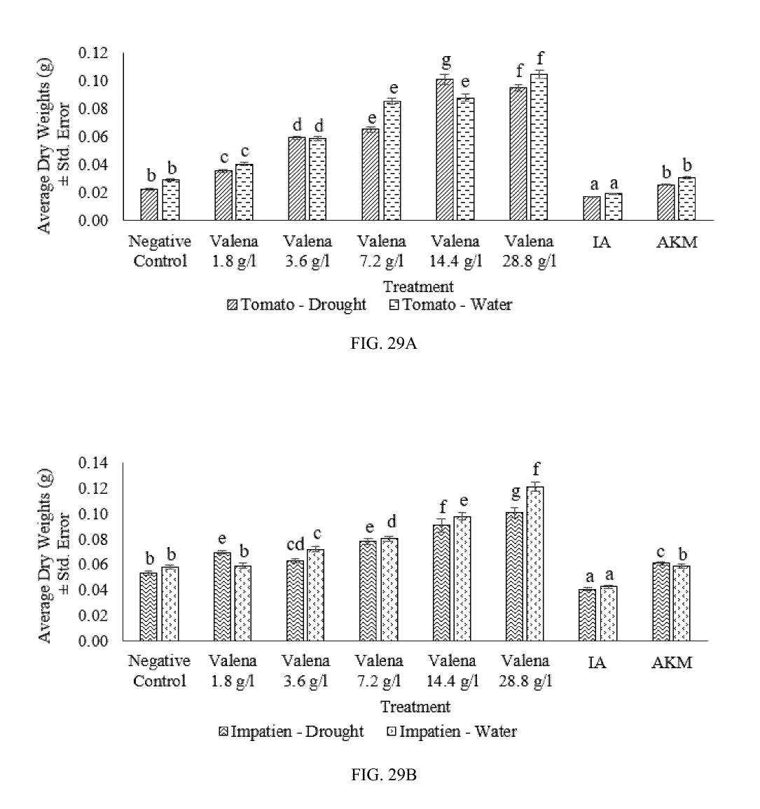

Tomato root scores ranged from 1.9 to 3.8 for the Valena treatments (FIG. 29A). The tomato Valena treatments showed a linear and significant increase over the negative controls, but the linear trend appeared to plateau between 7.2 g/L and 14.4 g/L of Valena. The watered negative control was 1.4 and the drought stressed negative control was 1.0 for root score. The IA positive control was equal or lesser than the negative control tomatoes while the AKM positive control did slightly better than the negative control tomatoes. For the impatiens, the root scores ranged from 2.5 to 3.7 (FIG. 29B). The impatiens Valena treatments showed a linear and significant increase over the negative controls, but the linear trend appeared to plateau near 14.4 g/L of Valena. The watered negative control was 2.5 and the drought stressed negative control was 2.1 for impatiens. The IA was lower than the negative control and the AKM did equal or better than the negative control but both competitor positive controls performed lower than the Valena treatments.

Soil amendment Valena treatments were able to effectively demonstrate biostimulant properties on the young seedling plants for tomatoes and impatiens. The lowest rate of 1.8 g/L to 28.8 g/L growing media were able to show increasing and positive growth parameters without showing any stunting or phytotoxic concerns. Interestingly, the competitor controls which also contains beta-glucans in the form of laminarin, a combination of 1,3- and 1,4-beta-glucans typical of kelp extracts [5], did not perform as well as Valena. It is important to note that kelp-based products also contain some plant hormones and mineral nutrients that are marketed to work in combination with the laminarin to provide the biostimulant effect [1, 5]. For the comparative evaluated application rate of 1.8 g/L, Valena demonstrated a greater biostimulant effect than AKM. Though it is difficult to know the equivalence level for comparison for IA because the effective percent composition of kelp extract is not disclosed, the recommended usage rate for the IA did not perform as well as the lowest rate of Valena evaluated in this trial.

Another potential benefit of plant biostimulants is abiotic stress tolerances, thus another aspect of the present invention relates to methods of applying Valena (Euglena gracilis, 50% beta-glucan) to increase drought tolerance of young plants. The investigators found that the drought stressed plants performed well at all treatment rates over the negative control and only slightly behind the watered plants for the Valena treated plants.

Overall, Valena treatments at all rates did show an increase in size and weight without seeing a determent to the plants at the highest rates. This information will be helpful to customers to know they should not see a decrease in plant size or detriment if high rates of Valena are used. Valena is a good soil amendment that should be considered when growers what to push their young plant crops in production for increased growth and vigor.

### Example 4

Materials and Methods

Tomato seeds (Solanum lycopersicum) were purchased from Ball Seed Company (West Chicago, Ill.). An all-purpose growing media, Berger BM6 (Hummert International, Earth City, Mo.), was used throughout the trial. Tomato seeds were planted (mid-November) into untreated growing media in two 288-cell plug trays and grown in a corrugated plastic greenhouse with radiant heat, fans, and pad cooling. The day and night temperatures were set at 75° F. and 65° F., respectively. Plants were watered twice daily and grown under ambient light intensities with no supplemental lighting for four weeks.

After four weeks, plugs were ready for transplant and treatment application. Table 12 describes the design of the trial for a total of 504 plants. The trial evaluated two application methods (1) top dressed or (2) soil incorporated. Growing media was treated with Valena (Euglena gracilis, 50% beta-glucan) (0.75-12 g/L growing media, Kemin Agrifoods North America (KANA), Des Moines, Iowa) or AKM (1.5 g/L growing media, competitor positive control). For top dressed application, plugs were transplanted into untreated growing media in 1-gallon pots then treatment was applied around the base of the plant on the top of the growing media. For soil amended application, Valena was added to the growing media, mixed homogeneously, placed into 1-gallon pots, then the plugs were transplanted into the treated media. Three replicates with six plants each were randomized over ten tables. Greenhouse tables were alternated for drought stressed (odd numbered tables) and watered (even numbered tables) plants.

TABLE 12
Fruit trial design.

| Water | Application | Treat- | Inclusion | Plants/ | Repli- | Total |
|---|---|---|---|---|---|---|
| State | Method | ment | Rate (g/l) | Replicate | cate | Plant # |
| Watered | Top Dress | Un- | 0 | 6 | 3 | 18 |
| | | treated | | | | |
| Watered | Top Dress | Valena | 0.75 | 6 | 3 | 18 |
| Watered | Top Dress | Valena | 1.5 | 6 | 3 | 18 |
| Watered | Top Dress | Valena | 3 | 6 | 3 | 18 |
| Watered | Top Dress | Valena | 6 | 6 | 3 | 18 |
| Watered | Top Dress | Valena | 12 | 6 | 3 | 18 |
| Watered | Top Dress | AKM | 1.5 | 6 | 3 | 18 |
| Watered | Soil | Un- | 0 | 6 | 3 | 18 |
| | incorporated | treated | | | | |
| Watered | Soil | Valena | 0.75 | 6 | 3 | 18 |
| | incorporated | | | | | |
| Watered | Soil | Valena | 1.5 | 6 | 3 | 18 |
| | incorporated | | | | | |
| Watered | Soil | Valena | 3 | 6 | 3 | 18 |
| | incorporated | | | | | |
| Watered | Soil | Valena | 6 | 6 | 3 | 18 |
| | incorporated | | | | | |
| Watered | Soil | Valena | 12 | 6 | 3 | 18 |
| | incorporated | | | | | |
| Watered | Soil | AKM | 1.5 | 6 | 3 | 18 |
| | incorporated | | | | | |
| Drought | Top Dress | Un- | 0 | 6 | 3 | 18 |
| | | treated | | | | |
| Drought | Top Dress | Valena | 0.75 | 6 | 3 | 18 |
| Drought | Top Dress | Valena | 1.5 | 6 | 3 | 18 |
| Drought | Top Dress | Valena | 3 | 6 | 3 | 18 |
| Drought | Top Dress | Valena | 6 | 6 | 3 | 18 |
| Drought | Top Dress | Valena | 12 | 6 | 3 | 18 |
| Drought | Top Dress | AKM | 1.5 | 6 | 3 | 18 |
| Drought | Soil | Un- | 0 | 6 | 3 | 18 |
| | incorporated | treated | | | | |
| Drought | Soil | Valena | 0.75 | 6 | 3 | 18 |
| | incorporated | | | | | |
| Drought | Soil | Valena | 1.5 | 6 | 3 | 18 |
| | incorporated | | | | | |
| Drought | Soil | Valena | 3 | 6 | 3 | 18 |
| | incorporated | | | | | |
| Drought | Soil | Valena | 6 | 6 | 3 | 18 |
| | incorporated | | | | | |
| Drought | Soil | Valena | 12 | 6 | 3 | 18 |
| | incorporated | | | | | |
| Drought | Soil | AKM | 1.5 | 6 | 3 | 18 |
| | incorporated | | | | | |

To evaluate the two water states (watered or drought stressed) for this trial, a soil moisture probe (ECH2O EC-5, METER Group, Inc., Pullman, Wash.) was used to monitor moisture status of the growing media. A standard curve was made by drying 3,850 ml of growing media at 50° C. for 24 hours. The media was then evenly dispersed into 11 cells of 4-cell pack (350 ml) trays, the same volume holds 250 ml water. Cells were then watered 0-100%, in 10% increments (volume of water to volume of growing media), (i.e. 10%=25 ml water in 350 ml media, 20%=50 ml water in 350 ml media, etc.) and mixed. After waiting 10 minutes to ensure absorption of the water to the media, each cell was measured with the soil moisture probe and a standard curve was created. Plants were drought stress from weeks 6 to 12. Five random plants were chosen per table and measured for water content twice weekly and recorded. Plants were fertilized (17-4-17 NPK, Greencare Fertilizers, Inc., Kankakee, Ill.) once weekly, at a rate of 1:100 ppm nitrogen, with a Dosatron injector from 6 weeks until the end of the trial (21 weeks). Bombus impatiens (Bumblebees, Natupol Excel, Koppert, Howell, Mich.) were also released at week 6 and kept for the entirety of the trial to pollinate the tomato plants.

Data Collection.

At days 60, 90, and 120, the number of buds, flowers, and tomatoes were counted and recorded for every plant and representative pictures were taken for each of the treatments. A tomato development scale was used to determine when tomatoes were at the breaker or red ripe stages (https://awaytogarden.com/what-color-is-your-tomato-how-to-ripen-them/). The first two breaker stage tomatoes were picked from each plant and measured for height, diameter, and weight, then placed on the lab counter to determine the shelf stability (length of time to turn red ripe). Two additional tomatoes were picked from each plant at the red ripe stage and measured for weight, soluble solids content (Reichert™ AR200 Handheld Digital Refractometer, Brix, Fisher, Pittsburgh, Pa.), and pH (A111, Orion Star, Thermo Scientific, Pittsburgh, Pa.). After day 120 and the four above described tomatoes were collected, all tomatoes were picked from the plants and weighed. StatGraphics® Centurion XV (Warrenton, Va.) was used for statistical analysis of the compiled data. One-way analysis of variance (ANOVA) were performed for 60, 90, and 120 day results and for each of the metrics for breaker and red ripe tomato data. Multifactor ANOVA was done comparing all treatments across the application and water states for the breaker and red ripe tomato data. Results were considered significant if the p-value was 0.05.

Results

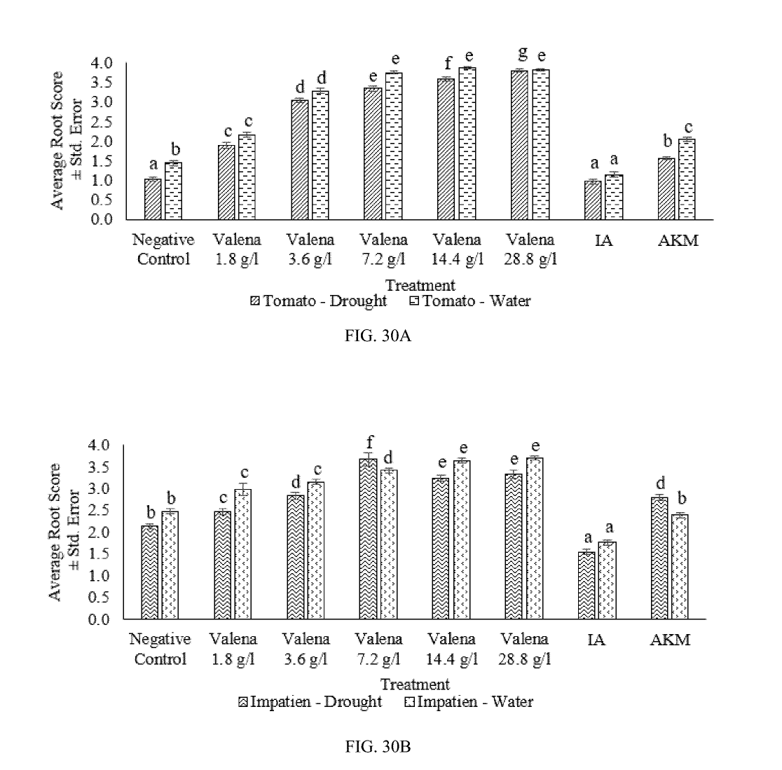

Bud, flower, and tomato counts were measured on days 60, 90, and 120 post-transplant. FIG. 30 has the results for bud counts for soil incorporated watered (FIG. 30A), soil incorporated drought (FIG. 30B), top dressed watered (FIG. 30C), and top dressed drought (FIG. 30D). The general trend for bud counts among all four treatments was low bud count at day 60, high at day 90, and lower bud count again at day 120. In a few cases the buds continued to be higher in count by day 120 but it was not consistent across application methods or water status (12 g/L Valena for soil incorporated watered, 3 g/L Valena and AKM for soil incorporated drought, 6 and 12 g/L Valena for top dressed watered, and 1.5 and 12 g/L Valena for top dressed drought). Table 13 shows the results of the multi-factor ANOVA for treatments with day as a covariate that indicates the no bud counts were statistically greater than the negative control. When comparing the four treatments with day as a covariate, the two drought treatments produced greater (p-value<0.05) buds than their watered counterparts (Table 14).

TABLE 13
Multifactor analysis of variance (ANOVA) for
bud results with day as a covariate comparing
Valena treatments, negative control, and AKM.

| | | | | Homogeneous |
|---|---|---|---|---|
| Treatment | Count | LS Mean | LS Sigma | Groups |
| Valena 3 g/l | 215 | 4.81578 | 0.361834 | X |
| Valena 6 g/l | 216 | 4.90622 | 0.360992 | XX |
| Valena 0.75 g/l | 216 | 5.0051 | 0.361111 | XXX |
| Valena 1.5 g/l | 216 | 5.48493 | 0.360992 | XXX |
| Negative Control | 216 | 5.59141 | 0.360992 | X |
| Valena 12 g/l | 215 | 5.78231 | 0.361833 | XXX |
| AKM | 216 | 6.08678 | 0.360992 | XX |

TABLE 14
Multifactor analysis of variance (ANOVA) for bud results with day
as a covariate comparing application method and water status.

| | | | | Homogeneous |
|---|---|---|---|---|
| Treatment | Count | LS Mean | LS Sigma | Groups |
| Soil incorporated - | 378 | 4.70781 | 0.272884 | X |
| Watered | | | | |
| Top Dressed - Watered | 377 | 5.1447 | 0.273265 | XX |
| Top Dressed - Drought | 377 | 5.63086 | 0.273256 | XX |
| Soil incorporated - | 378 | 6.04379 | 0.272884 | X |
| Drought | | | | |

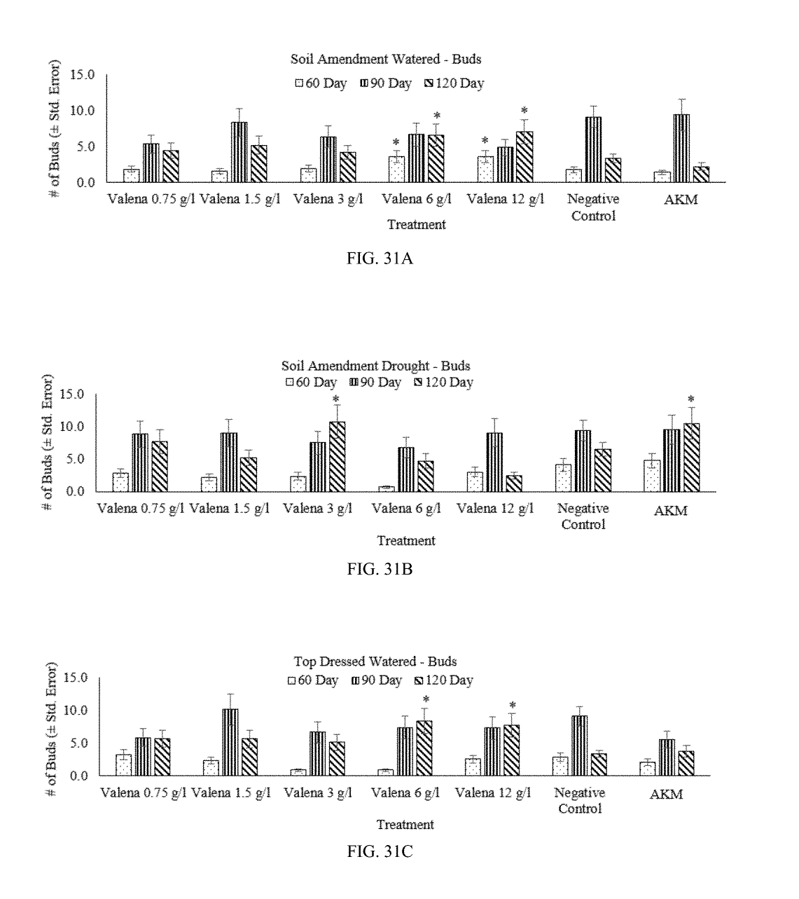

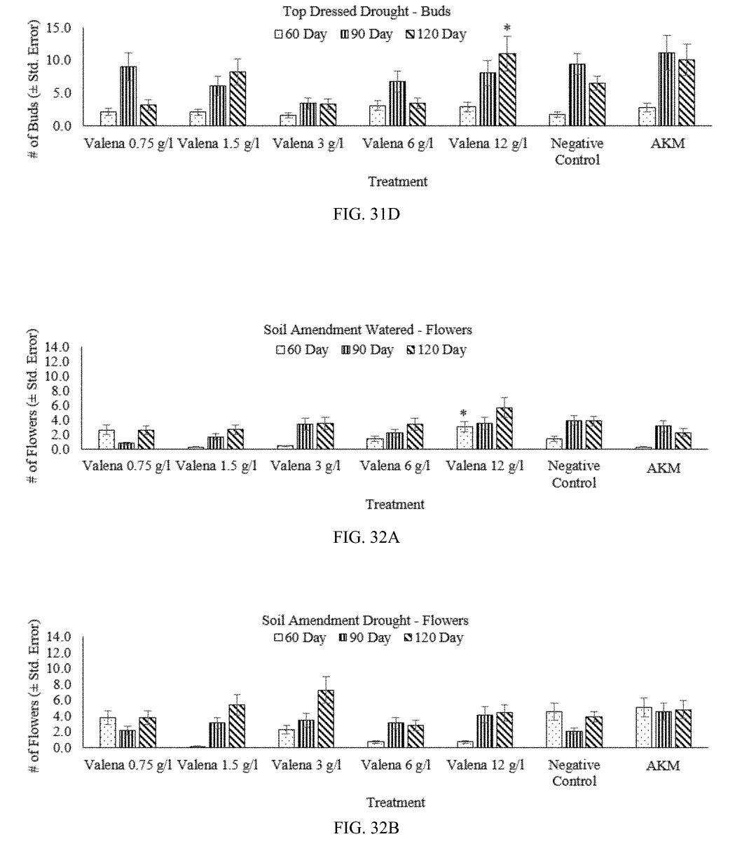

The flower counts are shown in FIG. 31 for the soil incorporated watered (FIG. 31A), soil incorporated drought (FIG. 31B), top dressed watered (FIG. 31C) and top dressed drought (FIG. 31D). There is no apparent trend with flower count over the days for any of the treatments. However, the multi-factor ANOVA for flower counts for treatments, with day as a covariate, (Table 15) indicates that the 12 g/L Valena treated plants were statistically (p-value<0.05) greater than the negative control. Also when comparing the treatments and water status, with day as a covariate, in a multi-factor ANOVA, again the drought treatments performed statistically (p-value<0.05) greater than their watered counterparts (Table 16).

TABLE 15
Multifactor analysis of variance (ANOVA) for flower
results with day as a covariate comparing Valena
treatments, negative control, and AKM.

| | | | | Homogeneous |
|---|---|---|---|---|
| Treatment | Count | LS Mean | LS Sigma | Groups |
| Valena 1.5 g/l | 216 | 2.60072 | 0.304557 | X |
| Valena 6 g/l | 216 | 2.74424 | 0.304557 | X |
| Negative Control | 216 | 3.05442 | 0.304557 | X |
| Valena 3 g/l | 215 | 3.17444 | 0.305268 | XX |
| Valena 0.75 g/l | 216 | 3.33664 | 0.304658 | XX |
| AKM | 216 | 3.48961 | 0.304557 | XX |
| Valena 12 g/l | 215 | 3.6622 | 0.305267 | X |

TABLE 16
Multifactor analysis of variance (ANOVA) for flower results with
day as a covariate comparing application method and water status.

| | | | | Homogeneous |
|---|---|---|---|---|
| Treatment | Count | LS Mean | LS Sigma | Groups |
| Soil incorporated - | 378 | 2.72638 | 0.230224 | X |
| Watered | | | | |
| Top Dressed - Watered | 377 | 2.76581 | 0.230545 | XX |
| Soil incorporated - | 378 | 3.44331 | 0.230224 | XX |
| Drought | | | | |
| Top Dressed - Drought | 377 | 3.67151 | 0.230538 | X |

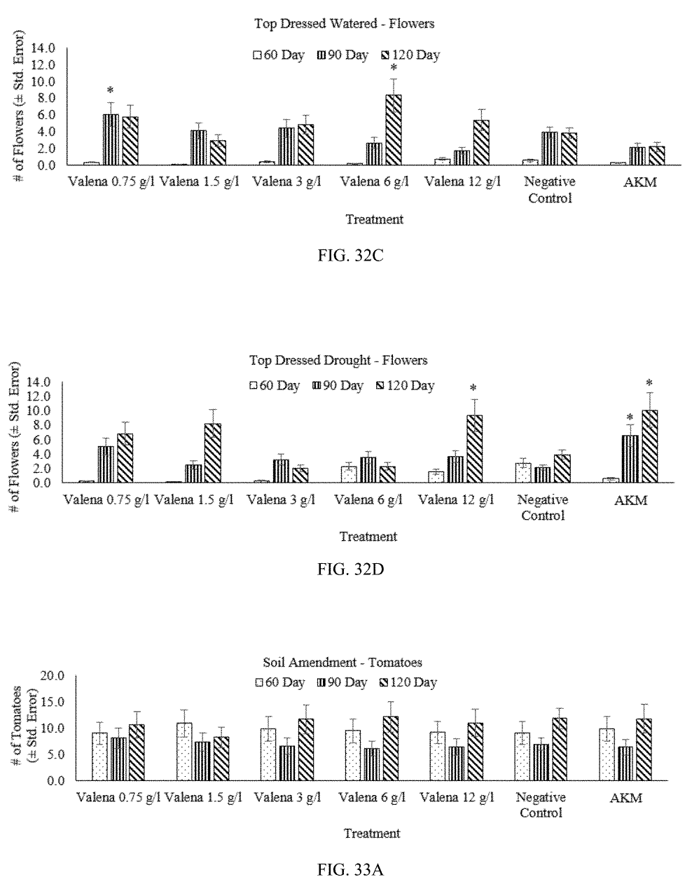

The high, low, high (60, 90, 120 day) trend for tomato counts can be seen in FIG. 32 for the four treatments except in negative control and AKM for soil incorporated drought and the 3 g/L Valena treatment for top dress watered. When comparing treatments in a multi-factor ANOVA (Table 17), with day as a covariate, the 1.5, 6, and 12 g/L Valena treatments and the AKM treatment had significantly (p-value<0.05) more tomatoes than the negative control. Table 18 compares the application and water status with day as a covariate and indicates the watered applications performed statistically (p-value<0.05) greater than the drought applications for tomato yield.

TABLE 17
Multifactor analysis of variance (ANOVA) for tomato
results with day as a covariate comparing Valena
treatments, negative control, and AKM.

| | | | | Homogeneous |
|---|---|---|---|---|
| Treatment | Count | LS Mean | LS Sigma | Groups |
| Negative Control | 216 | 8.49975 | 0.310201 | X |
| Valena 0.75 g/l | 216 | 8.74409 | 0.310304 | XX |
| Valena 3 g/l | 215 | 8.89241 | 0.310925 | XX |
| Valena 12 g/l | 215 | 9.20397 | 0.310924 | XX |
| Valena 1.5 g/l | 216 | 9.32845 | 0.310201 | XX |
| AKM | 216 | 9.64326 | 0.310201 | XX |
| Valena 6 g/l | 216 | 9.95808 | 0.310201 | X |

TABLE 18
Multifactor analysis of variance (ANOVA) for tomato results with
day as a covariate comparing application method and water status.

| | | | | Homogeneous |
|---|---|---|---|---|
| Treatment | Count | LS Mean | LS Sigma | Groups |
| Soil incorporated - | 378 | 8.5844 | 0.23449 | X |
| Drought | | | | |
| Top Dressed - Drought | 377 | 8.90187 | 0.23481 | X |
| Soil incorporated - | 378 | 9.33572 | 0.23449 | X |
| Watered | | | | |
| Top Dressed - Watered | 377 | 9.90373 | 0.234818 | X |

Breaker Tomatoes.

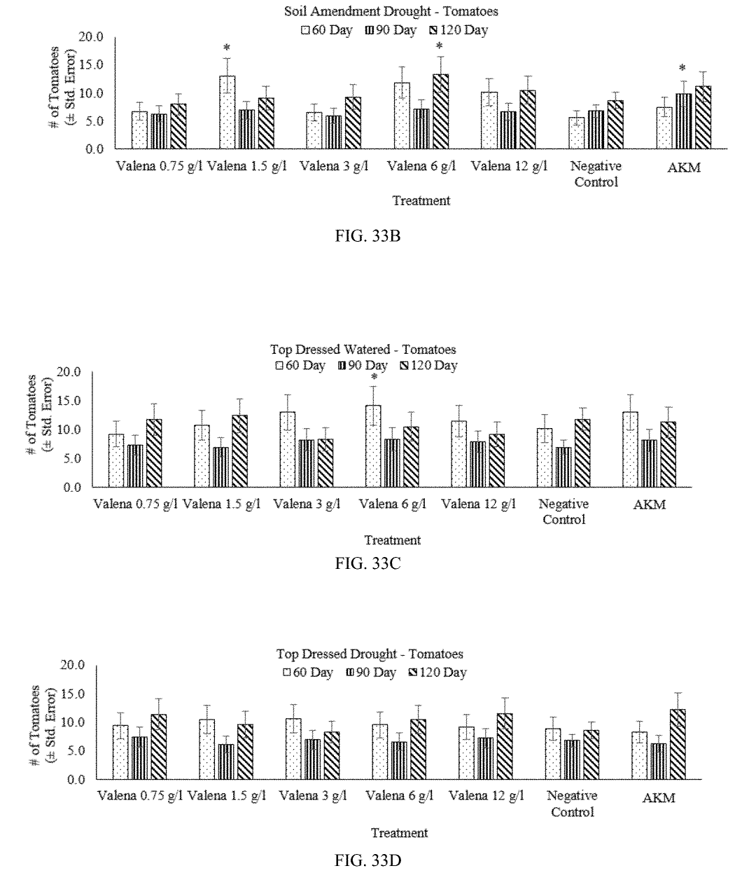

Height (cm), weight (g), diameter (cm), and shelf life stability (days) were all measured for breaker tomatoes comparing application method, treatment rates, and water status. FIG. 33 indicates the average tomato heights for soil incorporated application (FIG. 33A) and top dressed application (FIG. 33B) across rates and water status. One-way ANOVA indicated the top dressed, watered, 3.0 g/L Valena treated and 1.5 g/L AKM treatments were statistically significant (p-value<0.05) over the respective negative control. All tomatoes were between 5.0 and 6.7 cm tall. Table 19 is the multifactor ANOVA comparing treatments across the application and water states and indicates there was no significance for tomato height between treatments.

TABLE 19
Multifactor analysis of variance (ANOVA) for height
results of breaker tomatoes comparing all treatments
across application and water states.

| | | | | Homogeneous |
|---|---|---|---|---|
| Treatment | Count | LS Mean | LS Sigma | Groups |
| Valena 0.75 g/l | 144 | 5.28194 | 0.186269 | X |
| Valena 1.5 g/l | 144 | 5.28472 | 0.186269 | X |
| AKM | 144 | 5.37292 | 0.186269 | X |
| Valena 3 g/l | 144 | 5.37292 | 0.186269 | X |
| Valena 12 g/l | 144 | 5.51944 | 0.186269 | X |
| Negative Control | 144 | 5.64375 | 0.186269 | X |
| Valena 6 g/l | 144 | 5.65764 | 0.186269 | X |

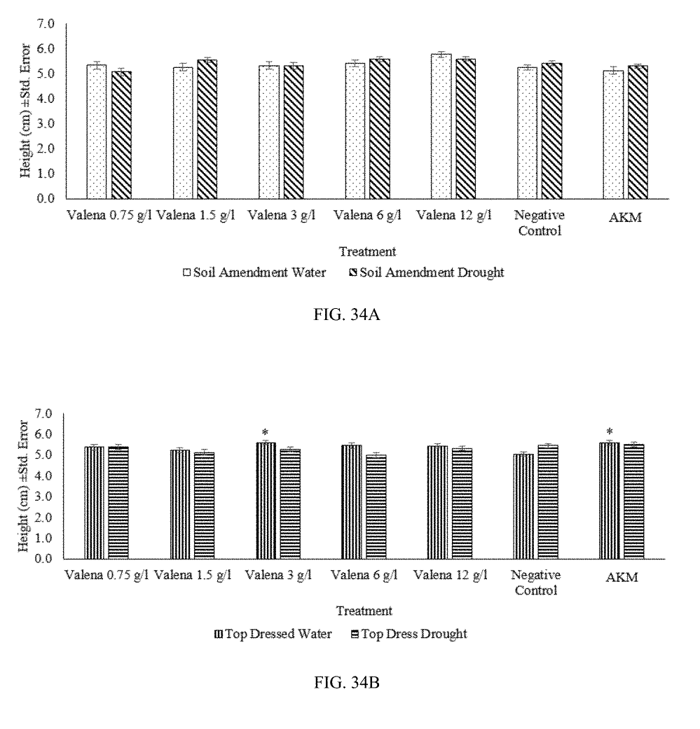

FIG. 34 indicates the average tomato diameters for soil incorporated application (FIG. 34A) and top dressed application (FIG. 34B) across treatment rates and water status. There was no apparent trend for diameter across application methods, treatment rates, or water status. All tomatoes were between 6.7 and 7.8 cm wide. Table 20 is the multifactor ANOVA comparing treatments across the application and water states and indicates there is a trend of higher treatment rate and wider tomatoes. The 3, 6, and 12 g/L Valena treatment rates were significantly greater than the negative control and AKM for tomato diameter.

TABLE 20
Multifactor analysis of variance (ANOVA) for diameter
results of breaker tomatoes comparing all treatments
across application and water states.

| | | | | Homogeneous |
|---|---|---|---|---|
| Treatment | Count | LS Mean | LS Sigma | Groups |
| AKM | 144 | 6.98056 | 0.0832613 | X |
| Negative Control | 144 | 7.05 | 0.0832613 | X |
| Valena 0.75 g/l | 144 | 7.12153 | 0.0832613 | XX |
| Valena 1.5 g/l | 144 | 7.15486 | 0.0832613 | XXX |
| Valena 3 g/l | 144 | 7.31458 | 0.0832613 | XX |
| Valena 6 g/l | 144 | 7.33472 | 0.0832613 | XX |
| Valena 12 g/l | 144 | 7.37153 | 0.0832613 | X |

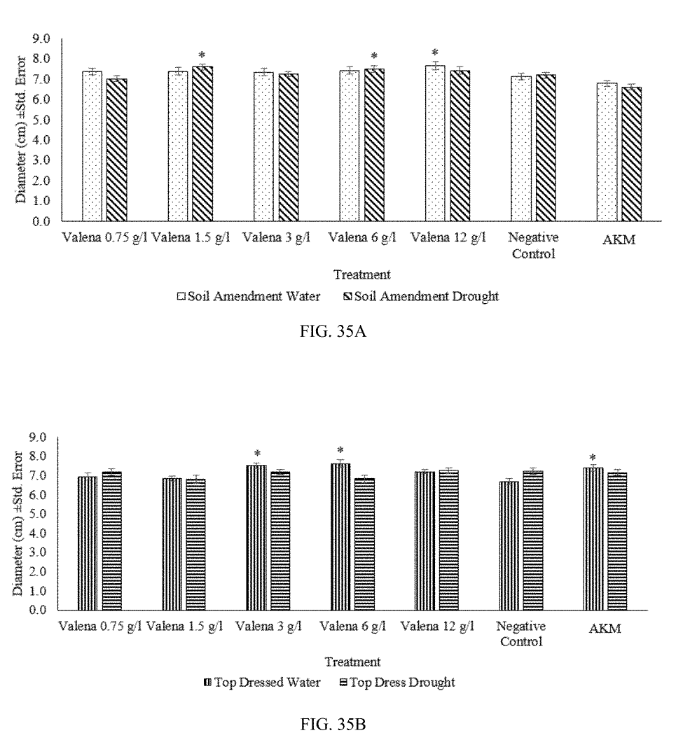

FIG. 35 indicates the average tomato weights for soil incorporated application (FIG. 35A) and top dressed application (FIG. 35B) across treatment rates and water status. There was a trend among application method and water status that with increasing treatment there was an increase in weight of the tomatoes. All tomatoes were between 129 and 228 g. Table 21 is the multifactor ANOVA comparing treatments across the application and water states and indicates there is a somewhat linear trend with increasing treatment rate and weight; however, only the 12 g/L Valena treatment rate was significantly greater than the negative control for tomato weight.

TABLE 21
Multifactor analysis of variance (ANOVA) for weight
results of breaker tomatoes comparing all treatments
across application and water states.

| | | | | Homogeneous |
|---|---|---|---|---|
| Treatment | Count | LS Mean | LS Sigma | Groups |
| Negative Control | 144 | 143.502 | 8.77341 | X |
| Valena 0.75 g/l | 144 | 143.522 | 8.77341 | X |
| AKM | 144 | 145.354 | 8.77341 | X |
| Valena 1.5 g/l | 144 | 147.526 | 8.77341 | X |
| Valena 3 g/l | 144 | 153.97 | 8.77341 | X |
| Valena 6 g/l | 144 | 162.915 | 8.77341 | XX |
| Valena 12 g/l | 144 | 186.804 | 8.77341 | X |

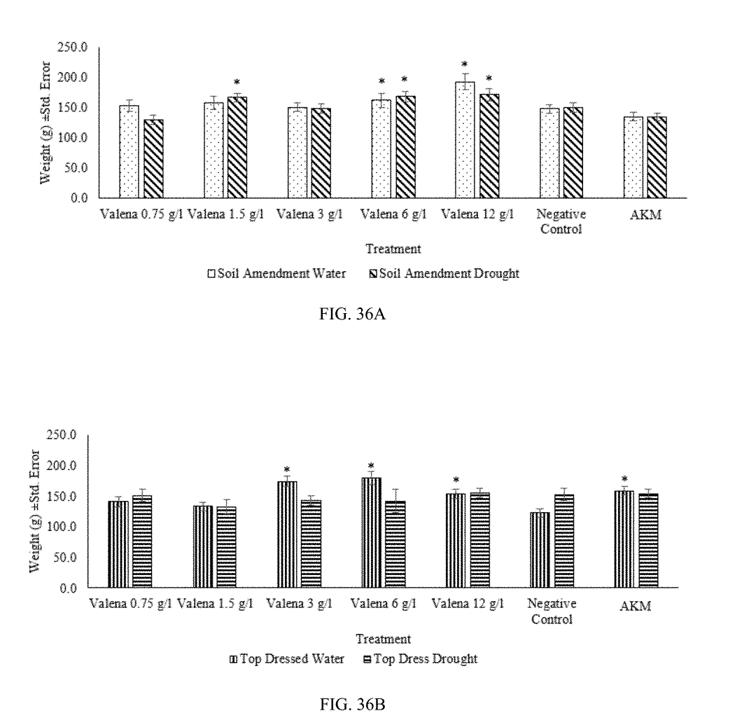

FIG. 36 indicates the average tomato shelf life stability for soil incorporated application (FIG. 36A) and top dressed application (FIG. 36B) across treatment rates and water status. The one-way ANOVA indicated that the 0.75 g/L Valena treatment for both the top dressed applications and the 3 g/L Valena treated top dressed watered were statistically (p-value<0.05) greater than the negative control. All tomatoes were between 15 and 23 days for shelf stability. Table 22 is the mulifactor ANOVA comparing treatments across the application and water states. The 12 g/L Valena treatment was statistically (p-value<0.05) lower than the negative control by two days.

TABLE 22
Multifactor analysis of variance (ANOVA) for shelf life
stability results of breaker tomatoes comparing all
treatments across application and water states.

| | | | | Homogeneous |
|---|---|---|---|---|
| Treatment | Count | LS Mean | LS Sigma | Groups |
| Valena 12 g/l | 144 | 18.2778 | 0.452902 | X |
| Valena 6 g/l | 144 | 19.3611 | 0.452902 | XX |
| Negative Control | 144 | 20.0833 | 0.452902 | XX |
| AKM | 144 | 20.1181 | 0.452902 | XX |
| Valena 3 g/l | 144 | 20.2986 | 0.452902 | XX |
| Valena 1.5 g/l | 144 | 20.4653 | 0.452902 | XX |
| Valena 0.75 g/l | 144 | 20.6875 | 0.452902 | X |

Red Ripe Tomatoes.

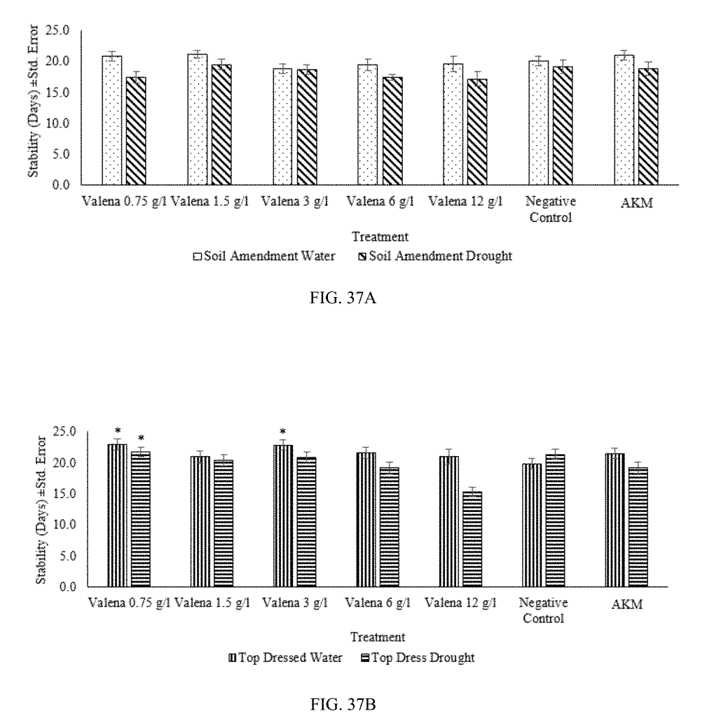

Weight (g), pH, and the soluble solids content were all measured for red ripe tomatoes comparing application method, treatment rates, and water status. FIG. 37 indicates the average tomato weights for soil incorporated application (FIG. 37A) and top dressed application (FIG. 37B) across treatment rates and water status. All tomatoes were between 114 and 175 g. Table 23 is the mulifactor ANOVA comparing treatments across the application and water states. The data indicates a linear increasing trend for weight and treatment rate with the rates >3 g/l of Valena being statistically significant (p-value<0.05) over the negative control.

TABLE 23
Multifactor analysis of variance (ANOVA) for weight
results of red ripe tomatoes comparing all treatments
across application and water states.

| | | | | Homogeneous |
|---|---|---|---|---|
| Treatment | Count | LS Mean | LS Sigma | Groups |
| Negative Control | 142 | 123.994 | 3.79111 | X |
| AKM | 143 | 124.498 | 3.77782 | X |
| Valena 0.75 g/l | 139 | 131.802 | 3.8319 | XX |
| Valena 1.5 g/l | 144 | 133.374 | 3.76464 | XX |
| Valena 3 g/l | 137 | 141.059 | 3.85977 | X |
| Valena 6 g/l | 143 | 152.994 | 3.77782 | X |
| Valena 12 g/l | 143 | 160.422 | 3.77782 | X |

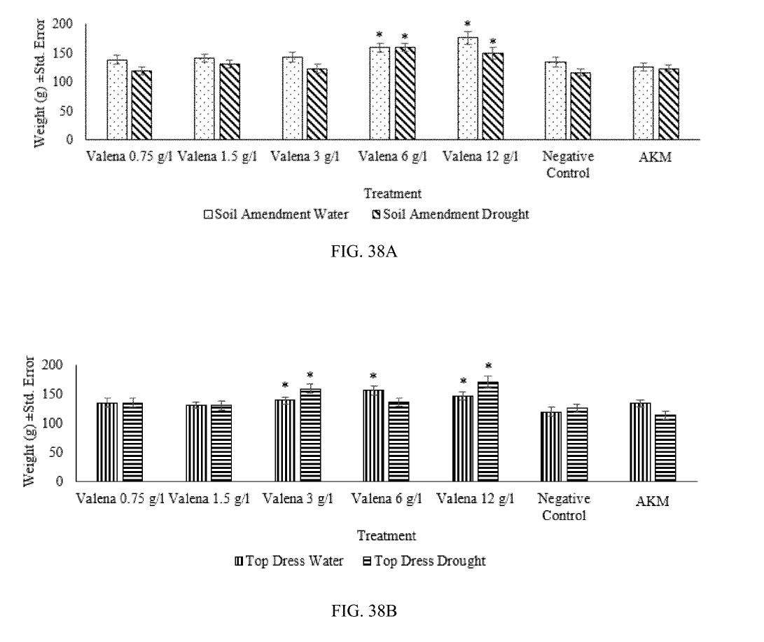

FIG. 38 indicates the average tomato pH for soil incorporated application (FIG. 38A) and top dressed application (FIG. 38B) across treatment rates and water status. One-way ANOVA indicates that all of the soil incorporated drought red ripe tomatoes were statistically (p-value<0.05) less than the negative control. All of the red ripe tomatoes pH were between 4.1 and 4.5. Table 24 is the multifactor ANOVA comparing treatments across the application and water states and indicates all but the 6 g/L Valena treated tomatoes had significantly (p-value<0.05) lower pH from that of the negative control.

TABLE 24
Multifactor analysis of variance (ANOVA) for pH
results of red ripe tomatoes comparing all treatments
across application and water states.

| | | | | Homogeneous |
|---|---|---|---|---|
| Treatment | Count | LS Mean | LS Sigma | Groups |
| AKM | 142 | 4.20908 | 0.0259316 | X |
| Valena 12 g/l | 143 | 4.23509 | 0.0258407 | XX |
| Valena 3 g/l | 137 | 4.24758 | 0.0264013 | XX |
| Valena 1.5 g/l | 144 | 4.24875 | 0.0257505 | XX |
| Valena 0.75 g/l | 139 | 4.2526 | 0.0262106 | XX |
| Valena 6 g/l | 143 | 4.30369 | 0.0258407 | XX |
| Negative Control | 142 | 4.33038 | 0.0259316 | X |

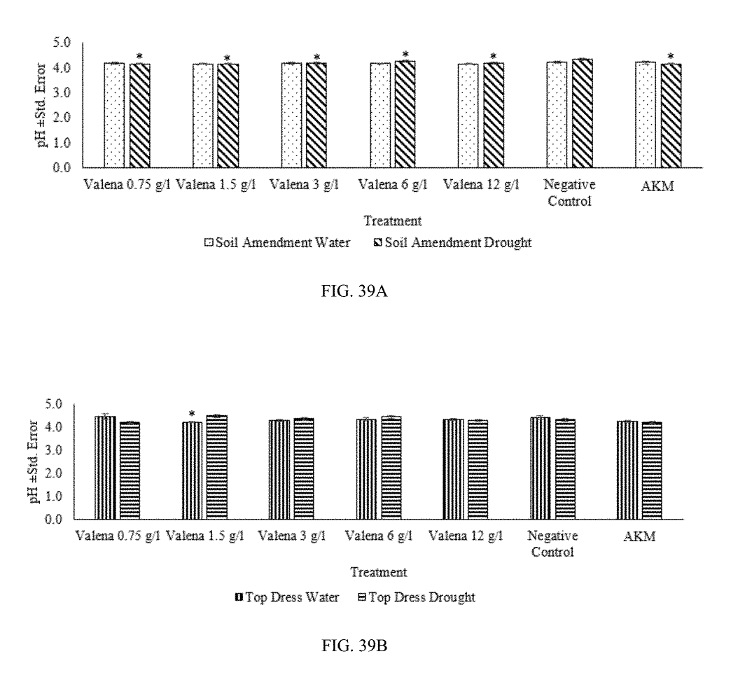

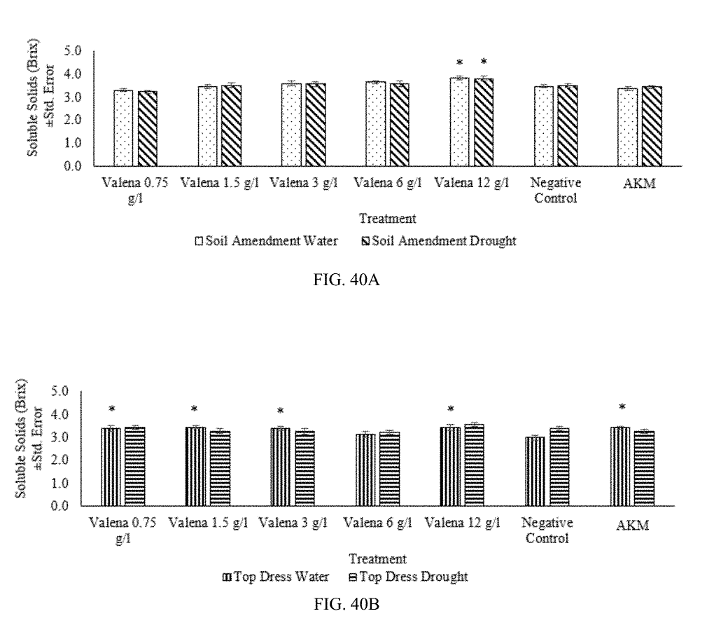

FIG. 39 indicates the average red ripe tomato soluble solids content for soil incorporated application (FIG. 39A) and top dressed application (FIG. 39B) across treatment rates and water status. One-way ANOVA indicated the 12 g/l Valena treatment as a soil incorporated application was statistically significant (p-value<0.05) over the respective negative control. Also, all except the 6 g/L Valena treatment for top dressed and watered plants were statistically significant (p-value<0.05) for increased soluble solids detected in the red ripe tomatoes. All tomatoes were between 3.0 and 3.8 Brix. Table 25 shows the mulifactor ANOVA comparing treatments across the application and water states and indicates the 12 g/l Valena treated tomatoes had significantly (p-value<0.05) higher soluble solids content.

TABLE 25
Multifactor analysis of variance (ANOVA) for soluble
solids (Brix) results of red ripe tomatoes comparing
all treatments across application and water states.

| | | | | Homogeneous |
|---|---|---|---|---|
| Treatment | Count | LS Mean | LS Sigma | Groups |
| Negative Control | 142 | 3.32049 | 0.0486455 | X |
| Valena 0.75 g/l | 139 | 3.32672 | 0.0491689 | X |
| AKM | 142 | 3.3605 | 0.0486455 | X |
| Valena 6 g/l | 143 | 3.38947 | 0.048475 | X |
| Valena 1.5 g/l | 144 | 3.41181 | 0.0483058 | X |
| Valena 3 g/l | 137 | 3.43713 | 0.0495266 | X |
| Valena 12 g/l | 143 | 3.64541 | 0.048475 | X |

Over the course of the trial, all of the tomatoes were picked and weighed. Table 26 shows the total weight yield produced for all the treatments regardless of application method or water status. There was a 12.9 to 34.6% yield increase with the Valena treatments and an 18.9% yield increase for the AKM treatment.

TABLE 26
Weight yield (kg) produced by treatments (N =
72) regardless of application method or water status.

| Treatment | Total Yield (kg) | % Yield Increase |
|---|---|---|
| Negative Control | 79.8 | — |
| Valena 0.75 g/l | 91.4 | 14.5 |
| Valena 1.5 g/l | 91.9 | 15.1 |
| Valena 3 g/l | 90.1 | 12.9 |
| Valena 6 g/l | 93.1 | 16.7 |
| Valena 12 g/l | 107.4 | 34.6 |
| AKM | 94.9 | 18.9 |

The purpose of this study was to evaluate the biostimulant effects Valena would have on the final fruit. By evaluating the bud, flower, and fruit counts over the three time points in the trial, there was nothing that stood out indicating Valena affected the fruit in that way. However, the drought stressed plants did produce significantly more buds and flowers than their watered counterparts which was counter intuitive since the watered plants produced significantly more tomatoes. This indicated that stressed plants put out more flowers in hopes producing seed for the next generation, but it was only those plants that later received sufficient water were able to produce the higher fruit yields. The top dressed applications also were greater than the soil incorporated applications, but was not always significant depending on the metric. These time points also indicated that several Valena (1.5, 6, 12 g/l) rates and the AKM produced more tomatoes regardless of application method and water status.

Breaker tomato data is important because tomatoes are picked at this stage by farmers and packed for shipping. Breaker tomatoes need to be of representative size and good shelf stability in order to ensure that they will be purchased by the final consumer. It was important to determine if Valena treatments could impact the size or stability as compared to untreated tomatoes. The breaker data showed that there was no change in height of the tomato but that there was a linear increase in diameter and weight with increased Valena treatments. Shelf life stability of Valena treated tomatoes decreased when the Valena treatment was increased; however, only the highest (12 g/L) treatment was statistically different. The overall weight yield picked from the plants indicates as much as a 34.6% (12 g/L Valena rate) increase over the negative control. At 0.75 to 3 g/L Valena rates, a 12.9% to 15.1% increase was seen in tomato yield.

The red ripe tomato data is important as it indicates the quality of the fruit for the final consumer. Tomatoes with lower pH and higher soluble sugar content provide a sweeter tomato taste [https://bonnieplants.com/library/the-basics-of-tomato-flavor/], however, tomato taste that remains unchanged with treatment would be just as desirable. The data shows that the pH lowered for the soil incorporated and drought stressed plants with increased treatment and remained unchanged for other treatments and the soluble solids content remained unchanged. Overall, it was expected that the tomatoes treated with Valena should taste similar or sweeter than the untreated tomatoes based on the acidity and soluble sugar measurements taken.

Thus, the inventors unexpectedly found that application of Euglena gracilis or paramylon promotes healthy growth in plants, including but not limited to flowers and crops, as shown herein by the trials across a variety of plants. For instance, through the course of the fruit trial, the present invention increased yield without negatively impacting the taste. With the world's ever-increasing world population, the demand to increase crop yield with the same acres of farmland has become increasingly important. The compositions and related methods disclosed herein could be one solution to aid growers to meet the increasing food supply demand.

The foregoing descriptions and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. A method for stimulating the growth of a plant comprising applying a composition containing whole cell Euglena gracilis or paramylon to the plant.

2. The method according to claim 1 wherein the composition is applied at a rate of at least 0.007 g/L.

3. The method according to claim 1 wherein the composition is applied at a rate ranging between 0.007 g/L to 28.8 g/L.

4. The method according to claim 3 wherein the composition is applied at a rate of at least 0.15 g/L to 14.4 g/L.

5. The method according to claim 4 wherein the composition is applied at a rate of at least 1.5 g/L to 6 g/L.

6. The method according to claim 1 wherein the composition is applied to the plant as a top dress application or soil incorporated application.

7. The method according to claim 1 wherein the composition is a dry powder.

8. A method for increasing abiotic stress tolerance in a plant comprising applying a composition containing whole cell Euglena gracilis or paramylon to the plant.

9. The method according to claim 8 wherein the composition is applied at a rate of at least 0.007 g/L.

10. The method according to claim 8 wherein the composition is applied at a rate ranging between 0.007 g/L to 28.8 g/L.

11. The method according to claim 10 wherein the composition is applied at a rate of at least 0.15 g/L to 14.4 g/L.

12. The method according to claim 11 wherein the composition is applied at a rate of at least 1.5 g/L to 6 g/L.

13. The method according to claim 8 wherein the composition is applied to the plant as a top dress application or soil incorporated application.

14. The method according to claim 8 wherein the composition is a dry powder.

15. A method for increasing crop yield comprising applying a composition containing whole cell Euglena gracilis or paramylon to a crop.

16. The method according to claim 15 wherein the composition is applied at a rate of at least 0.007 g/L.

17. The method according to claim 15 wherein the composition is applied at a rate ranging between 0.007 g/L to 28.8 g/L.

18. The method according to claim 17 wherein the composition is applied at a rate of at least 0.15 g/L to 14.4 g/L.

19. The method according to claim 18 wherein the composition is applied at a rate of at least 1.5 g/L to 6 g/L.

20. The method according to claim 15 wherein the composition is applied to the plant as a top dress application or soil incorporated application.
